(19) United States
(12) Patent Application Publication
(10) Pub. No.: US 2024/0244482 A1
(43) Pub. Date: Jul. 18, 2024

(54) METHOD AND DEVICE FOR CONTROLLING INTERFERENCE AMONG AUTONOMOUS WIRELESS COMMUNICATION LINKS

(71) Applicant: HUAWEI TECHNOLOGIES CO., LTD., Shenzhen (CN)

(72) Inventors: Martin Schubert, Munich (DE); Ramya Panthangi Manjunath, Munich (DE); Chan Zhou, Munich (DE); Wen Xu, Munich (DE)

(21) Appl. No.: 18/622,786

(22) Filed: Mar. 29, 2024

Related U.S. Application Data
(63) Continuation of application No. PCT/EP2021/076901, filed on Sep. 30, 2021.

(51) Int. Cl. H04W 28/02; H04B 17/336; H04W 28/06; H04W 92/18

(52) U.S. Cl. CPC H04W 28/0289; H04B 17/336; H04W 28/06; H04W 92/18

(57) ABSTRACT

Methods and related devices for performing congestion control in a decentralized way are provided, particularly for controlling interference among autonomous wireless communication links, such as sidelink communication. According to embodiments of the present disclosure, methods for performing congestion control comprise sending a cooperation message that includes a measured total interference and a cooperation mode indicator. Based on this cooperation message, other devices may voluntarily decide to join a coalition for perform congestion control.

### CROSS-REFERENCE TO RELATED APPLICATIONS

This application is a continuation of International Application No. PCT/EP2021/076901, filed on Sep. 30, 2021, the disclosure of which is hereby incorporated by reference in its entirety.

### TECHNICAL FIELD

Embodiments of the present disclosure is related to a method for controlling interference and congestion among autonomous wireless communication links (e.g. sidelinks or other) and a device comprising a receiver, a transmitter and a processor as well as a computer readable storage medium comprising computer executable instructions.

### BACKGROUND

The use of wireless communication devices like smartphones but also intelligent cars or other devices that communicate with each other over wireless communication means has increased significantly in the last two decades.

One way of such devices communicating with each other is the known autonomous sidelink communication where the communication between a transmitting device and a receiving device is provided via independent links. Each of the devices participating in the sidelink communication can be both, a transmitting and receiving device depending on whether it is, at a specific point in time, transmitting information or receiving information.

As a consequence of this way of communicating between different devices (also referred to as user equipment), it is not possible for a specific device to negotiate, with neighboring devices, sharing of transmission resources (like bandwidth or load, transmission power(s) of one or more devices, sub-channels, time slots etc.), because the specific device is not in communication with the other devices in the surroundings but only the device with which it is in sidelink communication. Furthermore, in the context of sidelink communication, there are no central supervising units or entities that would assign the transmission resources that are generally available (for example the respective bandwidth in a specific communication channel) to specific devices.

As a consequence, the transmission resources that are used by each device can be and must be selected at each device in a decentralized manner without there being a way to negotiate the amount of transmission resources to use with neighbouring devices.

This can lead to congestion where several devices attempt to use more transmission resources (like data rate and available bandwidth) than are actually available in view of the number of devices concurrently using the limited resources available.

Due to the lack of a centralized supervision of the provision of the transmission resources, the selection of the transmission parameters by each of the devices, even if adjusted in view of congestion, is usually not optimal, resulting in reduced performance specifically in scenarios where there is a plurality of devices attempting to access the same resources.

This can result in interference, reducing the experience of users and also reducing the reliability of the data transfer.

### SUMMARY

Embodiments of the present disclosure address, among others, the need for providing a way of decentralized cooperation management for providing congestion control overcoming the above discussed disadvantages.

In one embodiment, a method for sidelink communication congestion control is provided, the method comprising: causing, at a first device, a cooperation mode over a sidelink communication channel, wherein the cooperation mode is used to perform joint sidelink communication congestion control: broadcasting, by the first device, a first cooperation message, wherein the first cooperation message comprises a cooperation mode indicator and interference information indicative of a measured total interference power received at the first device, wherein the cooperation mode indicator is indicative of the cooperation mode: wherein one or more second devices are invited to join a coalition based on the first cooperation message.

In the context of the present disclosure, a coalition may be considered to refer to any number of devices that follow the same cooperation strategy, for example a cooperation strategy as may be defined by the cooperation mode indicator.

It is noted that the term “sidelink communication” is intended to encompass any autonomous communication links between devices and corresponding methods for communication. Particularly, actual sidelink communication is intended to be covered by this term.

A cooperation mode may, for example, specify a strategy for performing congestion control, like a specific approach to how resources are to be shared among devices and how each of the devices in a coalition is to determine their own available transmission resources. The cooperation mode indicator may additionally or alternatively indicate that the device is at all able or configured or “willing” to participate in a coalition.

Particularly, each cooperation mode may be defined by a certain optimization goal and/or a certain processing strategy for cooperated distributed congestion control and/or radio resource management. A device receiving the first cooperation message comprising the cooperation mode indicator may, when it decides to join the coalition, agree on cooperatively adapting their transmission parameters in line with the defined strategy/optimization goal in order to maximize a chosen accumulative performance measure.

By measuring the total interference power received at the device that sends the first cooperation message, congestion control can reliably be performed as the interference measured at each device allows for adjusting the transmission parameters or transmission characteristics at this particular device in order to reduce the overall experienced congestion.

In one embodiment, the causing comprises at least one of: the first device detecting at least one of an interference power exceeding a threshold, receiving a coordination request from at least one second device: periodically sending of cooperation message by configuration.

The case where the causing depends on detecting an interference power exceeding a threshold can particularly refer to the total interference power measured and/or a signal to interference plus noise ratio (SINR) and/or values derived from the SINR (like a performance or a link quality) exceeding a threshold that may be predefined.

This embodiment is to be understood as meaning that the first device is initiating a cooperation mode by broadcasting the cooperation message if one of the above-mentioned conditions is met. Particularly, if the first device detects an interference power that exceeds a threshold that, for example, indicates a high likelihood of congestion of sidelink communication, the first device may decide (for example on a pre-set basis or upon verification with the user of the device) to initiate or cause a cooperation mode. This can be efficient specifically in cases where there is measured only very little interference, resulting in congestion control not being necessary and consequently also the sending and broadcasting of the corresponding cooperation message can be prevented, thereby saving energy.

Upon receiving, from a second device, a cooperation message or any other coordination request that asks the first device to participate in congestion control, the device can then decide (for example also after having verified with the user of the device) to cause the respective cooperation mode. In this case, the cooperation mode can be the one that is encoded by the cooperation message.

In the third alternative, the congestion control method is permanently performed by the first device periodically sending a respective cooperation message due to a specific configuration. This configuration can be pre-set or it can be user driven by allowing the user to, for example, indicate to the device that congestion control is to be always performed or at least attempted, thereby instructing the device to periodically send a cooperation message, for example every second or every ten seconds.

It can further be provided that the first cooperation message further comprises at least one of: a transmission power of the first device, a sidelink ID, a sidelink direction, a device ID, a load, a priority, a rate demand, a power demand, a periodicity of sending the first cooperation message.

Generally, congestion control can already be performed by sending a cooperation message among the devices that comprise a measured total interference power. Based on this measured total interference power, it is then possible for each device to adjust their respective transmission power without further communicating with other devices. For example, if high interference power is measured by a specific device and it receives further cooperation messages that indicate further interference values that are larger or smaller than the one measured at the specific device, the device can control its own transmission power depending on the relative strength of the interference measured by the device itself compared to the interferences received from the other devices, for example as part of the respective cooperation messages.

By further providing, as part of the cooperation message, additional information like the transmission power or specific information pertaining to rate demands or power demands of the first device, the congestion control can be done in a more sophisticated way also taking into account for example quality of service requirements.

It can be provided that the method further comprise: receiving a second cooperation message from a second device, and/or participating in a coalition based on the second cooperation message or ignores the second cooperation message.

With this embodiment, a user device is given the opportunity to decide (particularly in connection or in interaction with the user of the device) whether or not to participate in a coalition to perform congestion control. This can be advantageous for example in cases where the interference experienced at a particular device is comparably small, making it less efficient with respect to the required energy to perform the congestion control. Also other circumstances, like preferences of the user, can be of significance here in order to decide whether or not the coalition is to be joined based on having received a cooperation message or whether the cooperation message (and potentially also at least one or all subsequent cooperation messages) is to be ignored.

In a further embodiment, the method further comprises: adjusting at least one transmission parameter associated with the sidelink communication at the first device.

A transmission parameter that is associated with sidelink communication may for example comprise the transmission power of a particular device or the load applied by a particular device or a transmission rate of a particular device. By adjusting these resources, the congestion experienced by the devices can be controlled reliably.

More particularly, the transmission parameter may comprise at least one of a transmission power, a transmission load, a data rate, a position of used resources, a number of used resource units.

It can further be provided that the cooperation mode comprises an optimization of one transmission parameter or the joint optimization of at least two transmission parameters, wherein the cooperation mode optionally comprises an optimal operating point of the plurality of participating devices regarding at least one jointly available resource.

In the context of this embodiment, a “jointly available resource” is to be understood as a resource that has an amount which is available to all devices simultaneously. For example, the available bandwidth in a specific communication channel is such a jointly available resource whereas, for example, the transmission power used by each of the devices is no jointly available resource as it can be adjusted by each device in isolation without having impact on the transmission power that can, in principle, be used by any of the other devices.

By adjusting the transmission parameters so as to achieve an optimal operating point (potentially also taking into account quality of service requirements) for all participating devices, a reasonable reduction of the experienced congestion is obtained while at the same time ensuring that each device can participate in sidelink communication.

In a further embodiment, the jointly available resource comprises an available link rate.

It can further be provided that the interference information indicative of a measured total interference power comprises information on measured interference in at least two distinct frequency bands.

With this embodiment, it is possible to adjust the transmission parameters of the device in particular frequency bands. For example, in case the congestion experienced over a first frequency band is comparably small, the device can adjust its transmission parameters to perform the sidelink communication over this frequency band, thereby reducing its own impact on the other frequency band for which high interference power may be measured.

Embodiments of the present disclosure further pertain to a device comprising a receiver, a transmitter and a processor: wherein the processor is suitable for causing a cooperation mode over a sidelink communication channel, wherein the cooperation mode is indicative of performing joined sidelink communication congestion control: wherein the transmitter is suitable for broadcasting a first cooperation message, wherein the first cooperation message comprises a cooperation mode indicator and interference information indicative of a measured total interference power received via the receiver, wherein the cooperation mode indicator is indicative of the cooperation mode.

The receiver and the transmitter can also be provided in a transceiver and it is not necessarily the case that the receiver and the transmitter are provided as physically separate entities. Particularly, the device may be a smartphone or a wireless communicating component of a car or other mobile device. With this device, reliable congestion control can be performed particularly in cases where there is a high density of devices communicating by means of sidelink communication.

It can further be provided that the processor is suitable for causing the cooperation mode over a sidelink communication channel upon at least one of: detecting at least one of an interference power exceeding a threshold, when receiving a coordination request from at least one second device: periodically sending of cooperation message by configuration.

By causing the cooperation or initialization of the cooperation depending on one of these conditions, it is ensured that congestion control can be performed where needed but may not be performed if it is not needed or not reasonable, for example in view of the required energy for performing the congestion control compared to the potentially saved energy by performing the congestion control.

In one embodiment, the first cooperation message further comprises at least one of: a transmission power of the first device, a sidelink ID, a sidelink direction, a device ID, a load, a priority, a rate demand, a power demand, a periodicity of sending the first cooperation message. In a further embodiment, the receiver is suitable for receiving a second cooperation message from a second device, and/or the processor is suitable for causing the device to participate in a coalition based on the second cooperation message or ignore the second cooperation message.

Thereby, participating in congestion control can be rendered dependent on, for example, a decision of a user, leaving control of the communication of the user's device completely to the user.

It can also be provided that the processor is suitable for adjusting at least one transmission parameter associated with the sidelink communication at the device.

This adjusting by the processor can comprise that the processor controls the transmitter so that the transmitter transmits signals depending on the transmission parameter to be adjusted. For example, the processor can cause the transmitter to transmit signals with a given transmission power depending on the optimization performed when carrying out the adjustment of the transmission parameter in line with embodiments of the present disclosure.

More specifically, the transmission parameter may comprise at least one of a transmission power, a transmission load, a data rate, a position of used resources, a number of used resource units.

It can further be provided that the cooperation mode comprises an optimization of one transmission parameter or the joint optimization of at least two transmission parameters, wherein the cooperation mode comprises an optimal operating point of the plurality of participating devices regarding at least one jointly available resource.

In a more specific embodiment, the jointly available resource comprises an available link rate.

By adjusting the transmission parameters of the devices in this decentralized manner, a reliable congestion control is performed while avoiding the need for any central supervision of this congestion control approach.

In one embodiment, the interference information indicative of a measured total interference power comprises information on measured interference in at least two distinct frequency bands.

By taking into account potential interference over at least two different frequency bands, the congestion control can be performed in a more efficient way by adjusting the transmission parameters with respect to each of the potentially used frequency bands.

Moreover, embodiments presented herein pertain to a computer-readable storage medium comprising computer-executable instructions that, when executed by a computing device, cause the computing device to perform a method according to any of the preceding embodiments.

### BRIEF DESCRIPTION OF THE DRAWINGS

FIG. 1 shows a schematic depiction of interference caused by autonomous user equipment in the context of wireless communication;

FIG. 2 shows a flowchart of a method according to one embodiment of the present disclosure:

FIG. 3 shows a schematic depiction of broadcasting aspects according to embodiments of the present disclosure:

FIG. 4 shows different embodiments of broadcasting via sidelink receivers and transmitters:

FIG. 5 shows an embodiment pertaining to asynchronous broadcasting via second stage SCI:

FIG. 6 shows a schematic depiction of how cooperation information and the cooperation mode indicator can be broadcasted:

FIG. 7 shows a schematic depiction of how transmission power can be updated according to one embodiment:

FIG. 8 shows a schematic depiction of cross-link interference in dynamic TDD systems:

FIG. 9 shows a schematic depiction of a plurality of devices participating in sidelink communication according to one embodiment:

FIG. 10 shows a flowchart of a method for congestion control according to one embodiment:

FIG. 11 shows a further flowchart of providing congestion control according to one embodiment:

FIG. 12 shows a schematic depiction of a device for performing methods according to embodiments of the present disclosure.

### DETAILED DESCRIPTION

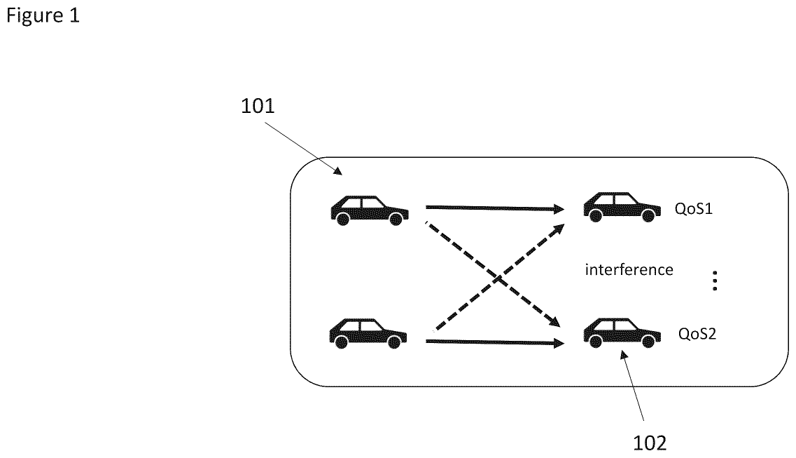

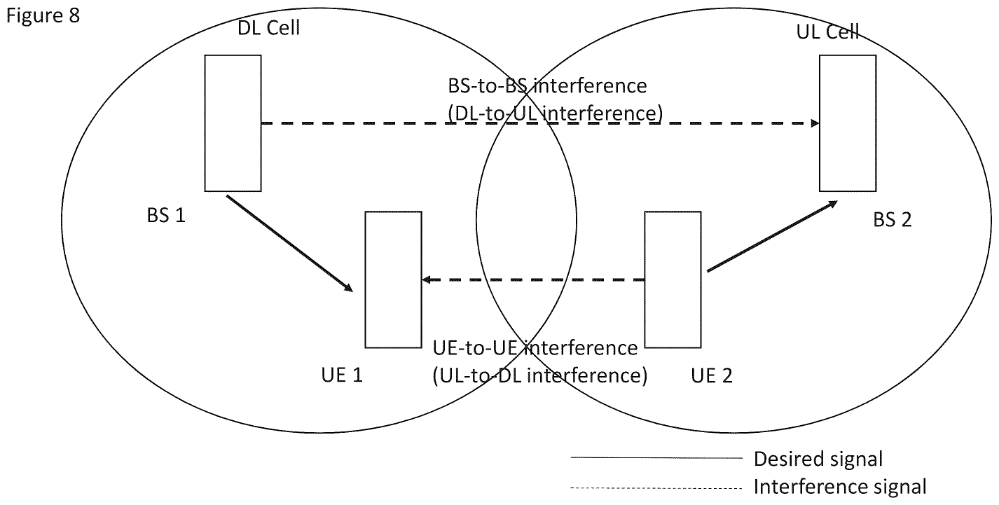

In the description that follows, explanations with respect to FIGS. 1 and 8 provide further information on the technical background and embodiments of the present disclosure pertaining to systems and methods for providing congestion control, particularly in dense environments where there are a plurality of devices that participate in sidelink communication in close proximity to each other.

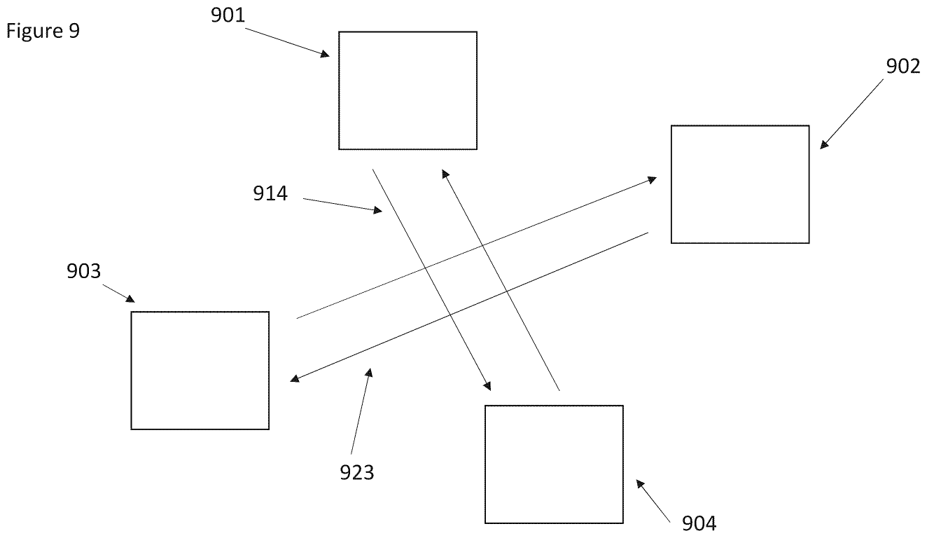

The description that follows and pertains to the FIGS. 9 to 12 then provides further explanations with respect to embodiments also described in relation to FIGS. 1 to 8.

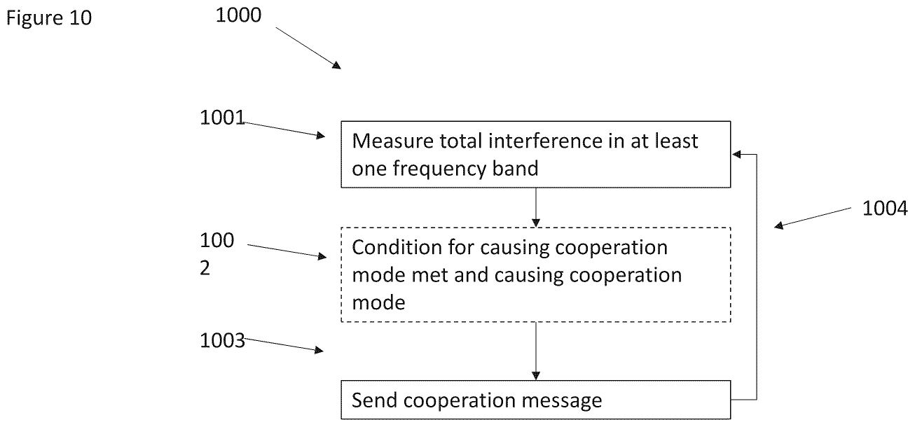

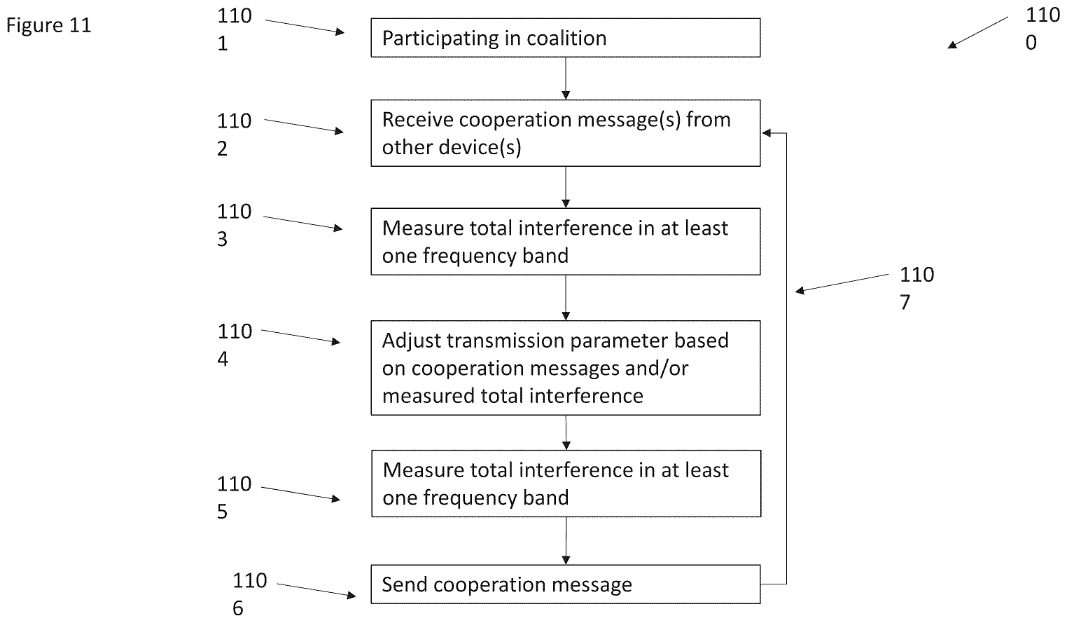

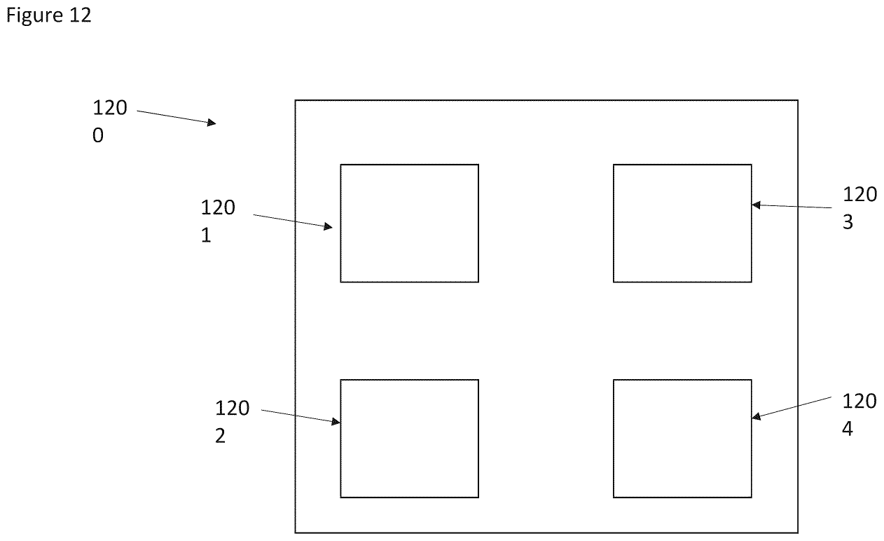

It is intended that the embodiments described in relation to FIGS. 9 to 12 can be combined with each and every embodiment described in relation to FIGS. 1 to 8. Specifically, the detailed options for performing congestion control (specifically the computer implemented-methods and method steps involved therein) as described in relation to FIGS. 1 to 8 are disclosed and intended to be combinable with the approaches for performing congestion control according to the methods described in relation to FIGS. 10 and 11 in a device as described for example in relation to FIG. 9 or 12.

FIG. 1 shows basic background information for some embodiments of the present disclosure:

Communication between transmitting (Tx) 101 and receiving (Rx) 102 User Equipment (UE)s is happening via independent links (e.g. autonomous sidelink communication), as illustrated in FIG. 1. This means that the transmitting UE 101 does not have a direct control channel with neighbouring UEs, e.g. to negotiate and reserve transmit resources. Furthermore, there is no central unit to assign the transmission resources. Thus, transmission resources must be selected at each UE in a decentralized manner.

The present disclosure relates, in this context, to some or all of the below indicated issues:
Targeted scenario(s): a plurality of devices communicating (for example pairwise) via independent wireless links in dense scenarios (i.e., dense deployment, full buffer traffic)
The particular choice of transmission resource at one Tx-UE potentially creates interference to Rx-UEs belonging to other links.
Each transmitting UE must select transmit resources (frequency band/carrier, time slot, and transmission power) and other transmit parameters (bit rate, priorities, rate targets, etc). Ideally, this selection should be made jointly for all transmitting UEs, while taking into account mutual interference, in such a way that certain desired QoS parameters (e.g. data rate, latency, reliability) can be satisfied globally (for all involved communication links). However, due to the underlying restriction of independent links, such a global optimization must be achieved by a decentralized approach. There is no central control unit that can control all these parameters.
The decentralized selection of resources at some transmitting UE can potentially cause interference at a receiving UE of another link, which is in the neighborhood. This can lead to frame collisions and packet loss, increased channel access delays, reduced effective communication range, and reduced effective throughput and spectral efficiency.

Technical problem/challenge addressed in this disclosure thus pertain to one or more of the following: Sub-optimal performance of decentralized resource selection strategies among independent wireless links in dense scenarios (i.e., dense deployment, full buffer traffic) due to lack of cooperation, thus causing excessive interference between links.

Particularly, the present disclosure may address the problem of cooperatively adjusting rate (d), load (p), and power (p), (see following definitions) to enable a reliable and spectrally efficient operation under a given QoS profile in a distributed way at network nodes that can/will perform cooperative adjustment by avoiding dedicated exchange of information (for reason of feasibility or prohibitive signaling overhead).
Thus, there is a need for a decentralized cooperation mechanism that is able to control the Tx resources, i.e., rate (d), load (p), and power (p), in such a way that the resulting interference experienced by neighboring links is tolerable. If this cooperative objective is not feasible due to the given conditions (e.g. weak channels, too demanding QoS/rate requirements, too much traffic per area, etc), then the mechanism should be able to detect this situation and provide a certificate informing about the “level of congestion”, i.e. how close the coalition operates to an infeasible state. This will allow for proactive measures to mitigate the situation and to avoid wireless dropouts, e.g. by reducing the rate demands or adjusting the user priorities.
One central aspect of this problem is to devise a strategy for enabling voluntary UE coalition building and cooperation, based on periodic broadcasting of asynchronous total interference measurements in combination with certain Tx parameters.
Another key aspect: the scheme presented herein, in some embodiments, avoids individual point-to-point control signaling and measurements between the UEs since this would create excess signaling overhead in dense scenarios.

The following definitions of terms are used throughout the present disclosure:
A “link” is defined as the data transmission between a single transmitting UE and one or more receiving UE(s). The present disclosure may, in some embodiments, focus on unicast links, but it also holds for multicast (groupcast) or broadcast links. In the following, subscript ‘n’ represents the link index.
N links in total will be considered, each characterized by a single transmitting UE. Typically, communication is bidirectional. That is, a UE is associated with both an incoming link and an outgoing link, which are separated by means of duplexing (e.g., Time Division Duplexing (TDD) is typically employed for sidelink). But communication can also be unidirectional (e.g. broadcast), in which case only the link characterized by the transmitting UE will be considered.
At the Tx side, the following parameters are used.
Kₙ: total number of available resource units in a resource pool from which the transmitting UE of link ‘n’ can select. For each link, the resource pool Kₙ can (but does not have to) be different, depending on the respective needs, e.g. the sharing of resources with simultaneous other links, e.g., the simultaneous transmission via UU and PC5 link in 5G NR.
Tx power p, measured in Watt or dBm, limited by pₘₐₓ. The Tx power is defined per resource unit. For all N transmitting UEs, the respective Tx powers are stacked in a vector p=[p₁, . . . , p_{N}]. Thus link n is can transmit with total Tx power upto Kₙpₙ for transmission in the resource pool.
Note: instead of using a single power pₙ, which is equal for all resource blocks of link ‘n’, the present disclosure, in some embodiments, readily extends to the case where individual resource units are power-controlled individually. This facilitates a finer granularity of controlling the resources and more flexibility for avoiding interference. In this case, pₙ is no longer scalar, but vector valued itself. It contains the power levels of all Kₙ Tx powers belonging to link ‘n’.
Load ρ: percentage of resource units (e.g. subchannels, subframes) used for transmitting data. This is closely related to the Channel Occupancy Ratio (CR). Considering some time slot t, for a link n, the CR (load, ρₙ) is the number of sub-channels selected in the subframe period of [t−a, t−l] and subframe period of [t, t+b] for it's transmissions, divided by the number of available sub-channels K. For all N transmitting UEs, the respective Tx load values are stacked in a vector ρ=[ρ₁, . . . , ρ_{N}].
Rate demand dₙ is the desired bit rate [bits/see] of a link n during the resource pool. Rate demands depend on service requirements and also individual link priorities. For all N transmitting UEs, the respective rate demand values are stacked in a vector d=[d₁, . . . , d_{N}].
At the Rx side, the data reception is corrupted by noise and interference, i.e., power cross-talk caused by the broadcast nature of the wireless channel.
Types of interference
   co-channel interference due to overlapping resources selected by the resource allocation
   cross-link interference due to uncoordinated duplexing
   other
Average interference Iₙ(ρ,p) of link n depends on load values ρ=[ρ₁, . . . , ρ_{N}] and Tx powers p=[p₁, . . . , p_{N}], used by other UEs in the surrounding. By adjusting ρ and p for all links, it becomes possible to control the mutual interference between the links.
Iₙ(ρ,p)=Σ_{m≠n}f(ρₘ, ρₙ)pₘg_{n,m} is the total interference measured at the receiving UE of link n.
   g_{m,n} is the path loss of the channel between the transmitter of UE m and the receiver of UE n.
   f(ρₘ, ρₙ) is the coupling factor, depending on the load variables at both transmitting and receiving link.
   Note that the quantity Iₙ(ρ,p) is being measured “as a whole”. That means that a particular definition of this quantity, for example on the basis of the interference caused by a particular device, is not necessary and will not be discussed in the following unless convergence of the algorithm is of interest.
The achievable data rate of each communication link is determined by the Signal-to-Interference-plus-Noise Ratio (SINR), which in turn depends on the mutual interference, especially for use cases involving high data rate traffic and dense connectivity (communication links per area).
   SINRₙ=pₙg_{n,n}/(Iₙ(ρ,p)+σ²), where σ² is noise power. This is defined per resource unit per link n (assuming same values for each resource block), or it can also be vector-valued, where individual values per resource unit are available, as mentioned above.
Achievable bit rate per resource unit per link n is given by: Rₙ=f′(SINRₙ). Eg. Rₙ=B log₂(1+SINRₙ) [bits per seconds] where
   Bandwidth per resource unit is denoted as B.
   again, this can be vector-valued

### Further Embodiments Relating to Resource Allocation

As mentioned before, the broadcasted interference and power values can be based on broadband measurements, averaged over all resources from the respective resource pool, or it can be per resource (e.g. subchannel). This means that the variables have an additional dimension, which are the resource units. That is, each rho and p and I is not dimension N (the number of links), but dimension N×K (the number of possible resource units).
In this specific context, the load variable ρ is not applicable, since resource allocation is not controlling the load, but individual resource units. That is, instead of optimizing with respect to p and ρ, the proposed scheme is optimizing the Tx power, but at a higher granularity, by allocating individual resource units. This does not change the basic concept of embodiments of the present disclosure. All the discussed steps remain valid.
If a resource unit is not being used, then the respective variables are zero. This does not need to be treated separately, but it is an immediate consequence of the iterative algorithm. If dₙ=0 is selected, which means “no data rate”, then fixed point iteration will automatically set all corresponding variables ρₙ and pₙ to zero. And if dₙ≠0, then the iteration will automatically fulfill this rate demand (if feasible), for the respective subchannel.
Particularly, at the transmitter with index n, the resources (here power and load as examples) may be updated periodically based on the newly received interference measurements I₁(ρ,p), . . . , I_{N}(ρ,p) as follows.

$${p}_{n} := {f}_{n} ( {I}_{1} ( ρ , p ) , … , {I}_{N} ( ρ , p ) )$$

$${ρ}_{n} := {g}_{n} ( {I}_{1} ( ρ , p ) , … , {I}_{N} ( ρ , p ) )$$

The functions fₙ and gₙ, for all links n=1, 2, . . . N, are such that the resulting iteration is converging towards a fixed point that is representing a certain operating point in the N-dimensional SINR feasible region.

A particular example is fₙ (I₁(ρ,p), . . . , I_{N}(ρ,p))=Iₙ(ρ,p)/norm(I₁(ρ,p), . . . , I_{N}(ρ,p)), which leads to the global optimum of the optimization target max minₙ SINRₙ subject to resource constraints. Other optimization targets lead to different functions fₙ and gₙ.

The problem of selecting the transmit resources and transmit parameters to avoid congestion while taking into account QoS profile has been addressed in the following ways in the prior art:
Decentralized congestion control (DCC), based on measuring the channel load. A common measure is the Channel Busy Ratio (CBR), see reference [1] (Mate Boban, Bengi Ayguen. Managing communication between a plurality of moving objects through control of transmit power and/or transmit rate: U.S. Ser. No. 10/440,666B2). The CBR is defined as the portion of subchannels whose RSSI exceeds a preconfigured value over a certain time duration. CBR-based DCC is employed, for example, in
   3GPP Mode 2 Sidelink (our preferred embodiment) and
   IEEE 802.11bd (evolution of 802.11p)
DCC only sets limits (e.g. channel occupancy ratio, CR) to resource allocation (by taking into account CBR and priority of the sidelink transmissions), but does not directly control or coordinate the resource allocation at different UEs. Typical actions taken by the DCC algorithm at a UE to meet the limit requirements include:
   Adapt data rate (e.g. adapt MCS (modulation and coding scheme), drop packet retransmission, drop packet transmissions)
   Adapt the load, i.e., Channel Occupancy Ratio (CR).
   Control transmission power (open loop) to reduce interference
In this context, so far according to the prior art, the following approaches have been applied:
   [1] proposes a scheme that adjusts the data rates, but unlike the present disclosure, it is mainly based on CBR.
   [2] (Renato L. G. Cavalcante, Martin Kasparick, and Slawomir Stanczak. Max-min utility optimization in load coupled interference networks. IEEE Trans. Wireless Commun., 16(2):705-716, February 2017) proposes a mathematical optimization framework for adjusting rates based on load, power, and rate demands.

The prior art experiences some drawbacks as will be discussed below.

In [2], mathematical analysis is done under idealized assumptions, resulting in the following characteristics and differences.
[2] proposes a generic, mathematical model. Global knowledge of all parameters is (mostly implicitly) assumed. This corresponds to the assumption of a centralized setup. In comparison, embodiments of the present disclosure offer a decentralized scheme, targeting the particular requirements of a decentralized scenario, including specific signaling, measurements, and processing details.
[2] considers a cellular context (interference between cells), while the present disclosure addresses autonomous links.
Summary of the main weakness: [2] is a generic mathematical model without specific signaling scheme, and it does not disclose the scheme which can be used in a distributed scenario.

Reference [1] proposes a practical DCC approach for autonomous UEs, based on CBR measurements. However, the approach conceptually differs from in the present disclosure in the following way. The present disclosure is not CBR-based but is based on interference and Tx-resource related information. While the CBR-based approach is a common method to decide whether the medium is congested or not, it has a number of disadvantages.
Main weakness: The CBR only measures the total load in terms of number of used resources. But it does not give information on the strength of interference. This information is lost through threshold operation included in the CBR definition. In addition, CBR is based on the RSSI, which measures the total power and not just the interference power. Therefore, the CBR does not allow to infer the actual physical interference power experienced at the receiver which can allow accurate transmit parameter adaptations. For these reasons, information-theoretic parameters like SINR and bit rate, which is commonly modeled as R=B log₂ (1+SINR), cannot be inferred directly from CBR, but only in very coarse approximation, which is not suitable for the realization of the present disclosure.
In addition, if the CBR is measured at the transmitting UE (where the transmission parameters are actually needed/decided), ‘hidden node’ and ‘exposed node’ problems can occur, since the transmission parameters depend on the interference, and interference happens at the receiver. This can lead to collisions or underutilized resources. Hidden node and exposed node problems can in principle be avoided by RTS/CTS handshake, but this is not practical for independent wireless links, which do not communicate via dedicated control channels. Also, negotiating resources by handshake would significantly increase the latency and signaling overhead.

Relying on dedicated interference measurements based on reference signals or similar from UEs present in the surroundings, will inevitably come with the overhead of scanning and measuring the individual links. In contrast, embodiments of the present disclosure do not require explicit knowledge of individual interferers' power levels. It is rather based on measuring the total interference power. This approach has the advantage that it is conceptually much simpler and causes less signaling overhead.

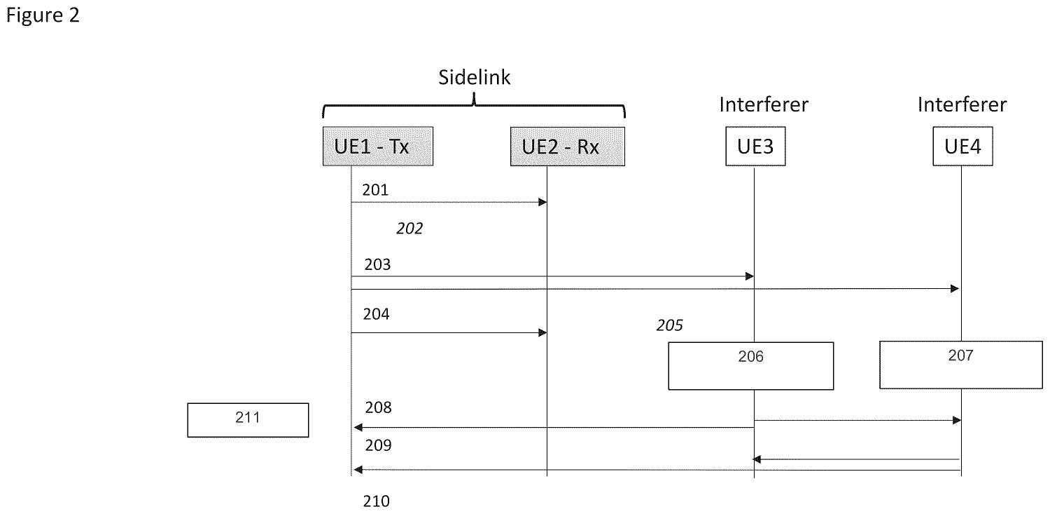

The FIG. 2 provides the chart of the proposed invention.

In a first step 201, the devices UE1 and UE2 establish a sidelink connection and perform sidelink communication as indicated in step 204.

Moreover, the device UE1 may propose, in step 202, a coalition to be build with the devices UE3 and UE4 (or at least one of them) or may invite them to join a coalition. For that purpose, The UE1 may end a cooperation mode indicator in step 203 as explained below. In step 203, UE1 initiates a coalition by sending a broadcast message to all UEs in the vicinity (within reach). This includes the following pieces of information.
a. Cooperation Mode Indicator, which declares to other UEs in the surrounding the preferred mode of cooperation, in order to invite other UEs to join the coalition on a voluntary basis.
   The Cooperation Mode Indicator selects a certain mode from a pool of possible modes, which are pre-defined and known to all UEs joining the coalition.
   Each mode is defined by a certain optimization goal along with a certain processing strategy for cooperative radio resource management (see embodiment for example). All UEs participating in a coalition agree on cooperatively adapting their transmit strategies in order to maximize the chosen cumulative performance measure.
b. Cooperation Information, which contains interference information (measured total interference) and Tx resource information (transmit power level, and data rate demand or priority). The Cooperation Information enables the UEs of a coalition to cooperatively adjust their respective transmission strategy (in particular, power, rate. and load) such that the chosen cumulative performance measure is optimized. The performance measure and optimization procedure is determined by the Cooperation Mode Indicator, as described above.
c. Optionally, also other information can be conveyed, e.g. the preferred periodicity of sending the broadcast message.

The broadcast signal from UE1 is then received by other UEs in the surrounding. In the figure, UE3 and UE4 are used as examples representing one or more UEs in the vicinity of UE1 that are able to decode the broadcast signal from UE1. Each receiving UE can react to the broadcast message in one of the following ways.
Join 206 and 207 the coalition by switching to the cooperation mode associated with the received Cooperation Mode Indicator. This means that the UE starts measuring interference and also starts periodically broadcasting Cooperation Mode Indicator and Cooperation Information (see the following steps 208 and 209).
Ignore the invitation (not explicitly shown). In this case the received broadcast message is discarded. Also, all following invitations can be discarded. The decision of not joining the coalition means that the UE keeps using its default resource management strategy and does not contribute to the coalition's cooperative strategy. As a consequence, the UE will not actively avoid interference to other UEs from the coalition. In return, it will also not receive the protection of the coalition in the form of interference avoidance.
If a UE does not recognize the indicated Cooperation Mode, e.g. because it is following an older version of the standard, then the invitation is implicitly ignored.

Only if UE3 has decided to join the coalition in step 206, then UE3 starts periodically broadcasting Cooperation Mode Indicator and Cooperation Information in step 208.
As a consequence, the UEs that form a coalition are cooperatively adjusting their transmission parameters based on the received cooperation information, with the common goal of optimizing a cumulative performance measure. As stated above, the specific way of cooperation is pre-defined among all UEs.
The step 209 is basically the same as step 208, but with UE4 instead of UE3 starting sending the respective information.
In step 211, which is depicted here separate from the device, within the coalition, each participating UE adapts load, transmission power and rate. This adaptation is based on the Cooperation Information, received by the UEs in the surrounding. This includes the total interference powers measured at the neighboring UEs, which have previously been broadcast as part of the Cooperation information. In particular,
   New Tx power: p_{new}=f(ρ, p, d), where function f may be monotone and sub-homogeneous of degree k, where k>=1.
   New load: ρ_{new}=g(ρ, p, d), where function f may be monotone and sub-homogeneous of degree k, where k>=1.
   New rate d may be chosen based on the values ρ, p, d, in particular the rate may be chosen such that the common optimization goal is feasible.
   One particular algorithm may be the one described above pertaining to the periodic updating of the received information.

Step 210 indicates that the process indicated in FIG. 2 is performed repeatedly, including for example that the cooperation mode indicators and relevant information, like the one broadcast in steps 203, 208 and 209, is repeatedly broadcast so as to invite other devices but also so as to repeatedly update the transmission parameters.

This approach provides significant advantages over what is known from, for example [1] and [2]. Compared to CBR-based techniques, the cooperation information-based approach allows for a precise control of the achievable link rates, e.g. Rₙ=B log₂(1+SINRₙ(p, ρ)), as a function of the transmit parameters powers p and load ρ (or only one variable).

The present disclosure allows a coordinated transmit strategy adaptation among independent links without involving dedicated signaling among different UEs.

The proposed broadcast information enables joint transmit strategy adaptation that can support multiple global objectives (e.g. max-min fairness, optimal resource efficiency, etc).

The proposed broadcast approach (as part of the present disclosure) is efficient in terms of signaling overhead, since it is based on total interference (e.g., from all UEs), and measuring the contained interference components individually is not needed. Knowledge of the source(s) of interference is not required, which significantly reduces the complexity of cooperation.

No handshake mechanisms are required and low signaling overhead is obtained based on asynchronous broadcast cycles.

The present disclosure enables independent control of broadcast periodicity means that the proposed scheme is operating asynchronously, where different UEs can choose a different periodicity, e.g. depending on their experienced channel fluctuations.

If the cooperation information is not only per UE but also per resource unit (or subchannel), then our algorithm even allows the control of individual resources, which is the basis for a unified approach for resource allocation and congestion control.

The proposed mechanism can co-exist with other transmit adaptation strategies. Also, since the cooperation information consists of standard-independent quantities, i.e. power levels, which optimizes compatibility and co-existence between different standards and systems, for example, the notion of radio power is standard-independent. The interference can be measured without needing to know the frame format etc. Even completely unknown sources of interference and noise are implicitly taken into account by the scheme, by measuring the total interference levels.

The execution of the proposed cooperative transmit strategy adaptation mechanism is completely voluntary. More specifically, in the context of the proposal, cooperation information-based approach facilitates:

Computation of the feasibility indicator, which is a precise indicator for how close to infeasibility the system is operating, is realized. This allows countermeasures even before the system is becoming congested, e.g. by signaling to higher layers (e.g. RRC) the request for reducing the service data rate.

The Tx power p, load ρ and rate d may be optimized jointly such that the coalition of autonomous UEs is guaranteed to achieve a Pareto optimal operating point, e.g. with respect to resource efficiency or spectral efficiency. That is, with embodiments of the present disclosure, it is possible to optimize rates under given resource constraints, or optimize usage of resources under given rate or QoS constraints. One example algorithm is the above described that periodically updates power and load.

Embodiments of the present disclosure thus pertain to a distributed scheme for cooperative adaptation of transmit strategy (e.g., rate demand, powers, load) for a coalition of UEs, which are autonomous, and the minimum required way of interaction is the periodic broadcast of cooperation information along with cooperation mode indicator and that is formed voluntarily by UEs and is flexible in terms of number of UEs in the coalition.

In some embodiments, the Cooperation Mode Indicator and cooperation information are broadcast from UEs that are part of coalition

In this context, it may be provided that the cooperation mode indicator has a fixed size of X bits and the additional Cooperation information, which may be based on the cooperation mode indicator, may have an additional size of Y bits.

Below a detailed description of some of the aforementioned aspects is provided, including:
cooperation information and how it is shared,
voluntary coalition building process
how the shared information is being processed
cooperation mode indicator

The cooperation information may specifically be broadcast from a UE in cooperation mode to other UEs in its vicinity. No acknowledgement of receipt is required and may also not be provided in some embodiments. In other embodiments, an acknowledgement of receipt may be provided, for example also including an indication that a particular device is willing to join the coalition.

Time Division Duplexing (TDD) on an unpaired spectrum may be used in some embodiments. This is the preferred mode for UE-UE communication (sidelink). The link direction may change dynamically and within short time intervals (order of milliseconds). There are some basic assumptions that will be assumed valid for the further description:
Each UE can take the role of a transmitter and a receiver.
UEs which do not act as transmitter do not play an active role in the cooperative scheme. Examples of such devices may be passive UEs listening in broadcast mode but without return link.

As a first description of the present disclosure, cooperation information will be discussed.
Cooperation information comprises of the following:
   Interference information Iₙ
      This is the total interference power, which includes all the interference contributions from other UEs in the surrounding, measured e.g. in Watt or dB.
         It can be obtained in the absence of the wanted signal.
         It can be computed by measuring the total received radio power and removing the power of the known wanted signal.
      It can also include other sources of interference and thermal noise. This is implicitly included.
      The interference power Iₙ is assumed to be normalized by the path loss of the link. Alternatively, the path loss factor can also be attributed to the transmitter. This may be done consistently throughout the whole cooperation scheme in some embodiments.
      The interference contributions can be averaged over a time window. The granularity of the measurement is configurable (e.g. per resource block, sub-channel, etc). The time period over which the interference is measured is flexible. For DCC this is typically the long-term average (e.g. hundreds of ms or more, depending on the dynamics of the system and channel). For resource allocation, it is typically shorter, in order to track the short scale fluctuations of the channel and to capture the instantaneous interference cross-talk between resource units.
      Alternate functions of the interference measured over time can be considered, such as average interference measured over time, maximum interference measured during a certain time interval, forecast of upcoming interference measurement based on previously measured interference values over time.
   The cooperation information may further comprise Tx resource information
      This represents the resource related variables being used in the Tx mode, e.g. priorities, and/or load, and/or transmit power, a function of one or more of these variables. In particular,
         Tx power, in dBm or Watt
         data rate priority, or absolute data rate in bps. UEs with higher priority can be treated with priority by Medium Access Control (MAC)
         and/or a function that combines the aforementioned parameters to a single value in order to facilitate compression of the amount of information to be broadcast, depending on the chosen transmit parameters adaptation strategy.

There may also be, in some embodiments, an alternate definition of “Cooperation Information”. Sharing of interference information is essential to at least some embodiments of the present disclosure. This is, it would already suffice to enable a simple power control scheme. In this sense, the Tx resource information can be regarded as optional (depending on the need of the chosen cooperation strategy). However, the combined sharing of interference information together with Tx resource information (which we refer collectively as “Cooperation Information”) offers a wide range of interesting algorithmic opportunities for DCC and resource allocation. This is a focus of some of the embodiments presented herein.

There are several options how this information can be provided.

As a first option and as was already discussed above, the values can be broadcast individually, by defining dedicated fields in the broadcast message. However, this can be difficult when the present disclosure is to be implemented together with already known standards. Preferably, the amount of broadcast information should be kept low.

Alternative, it can be provided that combined values are broadcast by sharing function of interference and Tx resource information. This would be a way of compressing the amount of broadcast data.

In a first example of this alternative, the interference and Tx power can be combined together, e.g. as a single SINR value. SINRₙ=pₙ/Iₙ

In a second example, the interference, Tx power and data rate demands can be combined together as: dₙ/B log₂(1+SINRₙ)

The proposed scheme can support a wide range of coalition objectives (described later) depending on the available cooperation information. Reduced set of information such as only load or transmit powers, results in fewer choices in coalition objectives.

Cooperation information can be representative of past transmissions from a UE or its upcoming transmissions.

Moreover, optional information like the additional information to cooperation information may be provided, comprising for example periodicity with which the cooperation information is broadcast to UEs in vicinity.

The cooperation information can be captured by each vehicle based on its transmissions and receptions. The precise information such as granularity, choice of interference representation, Tx resource information is linked to the cooperation mode indicator described later.

It will now be described how the interference information is measured/collected and broadcast.

At each UE, ‘interference’ is measured in receive mode.

At each UE, ‘tx resource information’ is captured for the transmissions from the UE.

Note that the TDD structure of links is not necessarily aligned, which means that interference from neighboring UEs might not be present (i.e. measurable) at any given time. Therefore, in some embodiments of the present disclosure the interference may be averaged, e.g., over a reasonable amount of time slots, in order to average out this effect. However, in principle, also the short term (instantaneous) interference may be measured additionally or alternatively. Sharing instantaneous total interference information can be realized by increasing the broadcast message rate. In addition, this can be done per sub-channel (i.e., frequency carrier) or as a single value representing the broadband interference, averaged over all frequencies.

The broadcast signal (containing cooperation information) can be received by all UEs in the surrounding (i.e. all UEs within a certain range). If any UE fails to receive the broadcast signal then this does not mean that the proposed scheme fails. It only means a lack of information, which may degrade the overall performance and reliability of the scheme, but will not lead to a breakdown/unstable behavior of the system. The missing values can, in principle, be replaced by heuristic guesses, e.g.
the interference level at one UE will often be similar to the interference level at a neighboring UE (correlation in space)
the interference levels will be correlated in time. That means that a missing value may be replaced by a previous one.
the interference levels will be correlated in frequency. This means that a missing value can be replaced on one subchannel, by a neighboring subchannel (or more generally a neighboring resource).

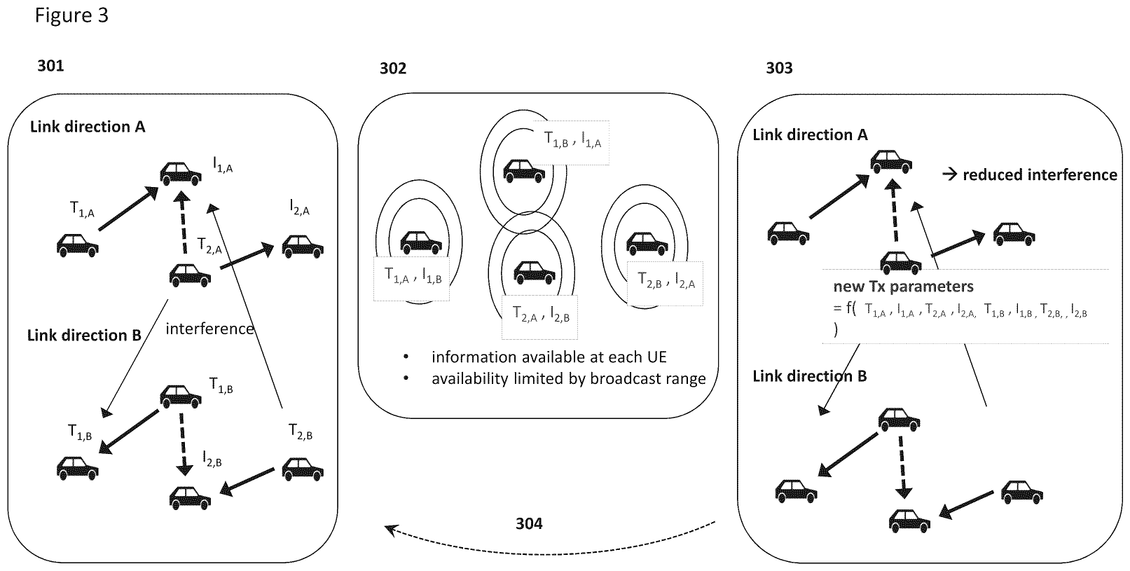

The FIG. 3 describes in detail the cooperation information and its broadcasting aspect of the invention.

Generally, bidirectional transmission is exploited. The Tx information (denoted T) is from one link direction, the interference measurement (denoted by I) is from the other direction.

In a first step 301 of the approach shown in FIG. 3, the Tx parameters and measurements are obtained, where T_{x,y} (where x is the link identifier and y denotes the direction of the link) represents the tx resource information (described previously). Similarly, I_{x,y} denotes the interference and these may also be measured in the step 301 either simultaneously or subsequently or even before the transmission parameters Tx are measured. Specifically, the transmission parameters may be obtained when the device is in transmission mode of the sidelink communication and the interference may be measured while the device is in receiving mode. The tuple (T_{x,y}. I_{x,y}) may constitute the cooperation information. Each UE, depending on the link direction can collect/measure the transmit resource and interference. In the figure, the bidirectional links between two pairs of UEs are explicitly shown for clarifying how the T_{x,y} and I_{x,y} information is collected/measured at the UEs.

The T_{x,y} and I_{x,y} information collected/measured at a UE is broadcast in step 302 to vehicles in its vicinity. The T_{x,y} and I_{x,y} that is broadcast is dependent on the cooperation mode indicator (described later).

Next, in step 303, UEs that receive the T_{x,y} and I_{x,y} and may be willing to cooperate with the other devices and to adjust their transmit parameters. Adaptation of UE tx parameters is based on the received broadcast information and cooperation mode indicator (described later).

The above three steps are repeated (indicated with step 304) as long as there is at least one UE that broadcasts the interference information. Alternative ways of broadcasting cooperation information may include one or more of the following:

In a first option, the step 302, i.e. the broadcasting, may be performed via sidelink receivers by sending the Tx information from transmitter to the receiver of a sidelink, and then broadcasting the cooperation information from the receiver.

Alternatively or additionally, the step 302 may be performed via sidelink transmitters by sending the interference information from receiver to the transmitter of a link, and then broadcasting the cooperation information from the transmitter.

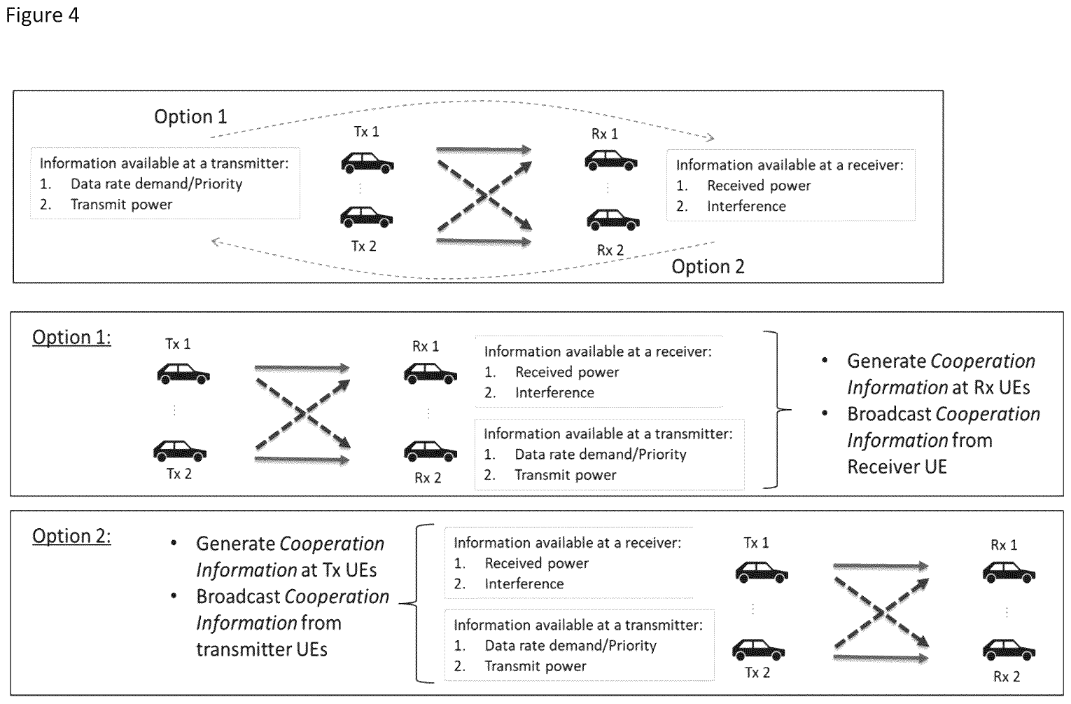

The FIG. 4 depicts the above options in detail.

In the following a voluntary coalition building process according to some embodiments of the present disclosure will be described that encompasses self-adapting coalitions based on flexible opting in/out of UEs.

Coalitions of autonomous UEs are initiated on a voluntary basis, based on broadcasting some information (described later) from one or more UEs to all UEs within their reach. Many DCC algorithms demand all UEs to cooperate. One aspect of the present disclosure is that the scheme presented herein offers flexible opting in/out, meaning the UEs can voluntarily decide to cooperate by opting to join or stay out of coalitions at any time. This allows the coalition to be “self-adapting”. The remaining UEs inside the coalition will continue adapting their Tx strategy (power, load, rates) in a cooperative manner, based on the information received from other UEs in the surrounding. No additional signaling or negotiation is required.

The UE(s) outside the coalition can follow another strategy, e.g. based on prior art described above to perform sidelink power control. Both strategies can co-exist. Opting out from cooperation can also be provided, because the whole scheme is based on interference measurements. Here, interference means total interference (as described previously). In some embodiments, it is not necessary to identify the individual interference components, for example based on dedicated measurements. This is an advantage of the proposed scheme, since it reduces complexity and improves flexibility. It can be provided that (only) the total Rx power (power received when in receiving mode) is measured and the useful (wanted) power that may pertain to the signal associated with the devices that are in sidelink communication with each other is subtracted. Then, this information (along with some Tx parameters as described previously) is broadcasted. If a UE leaves the coalition, then the interference measurements do no change. The interference contributions from UEs outside the coalition are still correctly included in the aggregate interference measurement. For the UE that has left, this means that it stops broadcasting. Then its SINR will no longer be part of the global optimization. The consequences of leaving the coalition can be good or it can be bad (in terms of achievable performance). In any case, it will not lead to an unstable behavior or break-down of the coalition. The “outside UEs” will just go back to the default mode of operation. The optimization used according to embodiments of the present disclosure is guaranteed to converge (for a given coalition), even if executed totally asynchronously. One preferred algorithm may be the above described for periodically updating power and load.

With the present disclosure, it is also possible to form multiple coalitions.

There is a possibility to form multiple coalitions, based on distinct sets of UEs. Each coalition can operate towards its own objective (e.g. max-min fairness, or optimal resource efficiency) depending on the respective QoS (quality of service) profile. Each UE at a time can be a part of only one coalition. Different types of coalitions can co-exist since aggregate interference measurement includes all interference components from UEs in the surrounding, no matter whether they are inside or outside the coalition.

There may also be one or more coalition objectives each coalition may attempt to fulfil or achieve, independent from other potentially coexisting coalitions.

For example, in order to ensure that the UEs adapt their transmit strategies towards a common objective within a coalition, it can be provided that first the common objective of the coalition is established.

Each UE that intends to trigger the execution of joint optimization may broadcast the following information to the vehicles in its vicinity in order to initiate a coalition.

A cooperation mode indicator may be broadcast that indicates how the shared cooperation information needs to be utilized and may comprise an objective of optimization problem (cooperation mode), one or more specific formulae or the like.

Particularly, the cooperation mode may indicate a common objective to which the UEs that join a particular coalition agree and the cooperation mode may comprise one or more of, for example:

Optimization of data rates (or more generally QoS) subject to resource constraints, e.g. max-min fairness, proportional fairness

Optimization of resource usage (e.g. power, load) subject to constraints on data rates.

This set of Cooperation Modes can be pre-defined, e.g. in the standard with supporting its update. Certain rules can be defined to make sure that coalitions are encouraged. For example, the preferred way of answering to an initial trigger could be to join the coalition. This can depend on the service.

Moreover, cooperation information may be provided as indicated already previously.

Additionally, optional information, like periodicity that indicates the periodicity of the broadcasts from the UE may be provided.

Each UE, upon decoding the above broadcast, may choose to either join or stay out of the coalition on a voluntary basis (flexible opting in/out).

When a UE agrees to join the coalition, it broadcasts the information (all or partial) stated above with the appropriate coordination mode indicator.

The triggering of coalition can be done by any UE in the network.

A UE participating in an ongoing coalition may either choose to ignore the recently received broadcast or update its cooperation mode indicator to be a part of another coalition on a voluntary basis.

A UE participating in an ongoing coalition may choose to start a new coalition by broadcasting information stated above with desired coordination mode indicator.

Alternatively, the idea also allows for a network entity such as a base station to determine the cooperation mode indicator and cooperation information that a set of UEs in the network need to use to adapt their transmit strategies, e.g. cell edge UEs.

Below, a first scenario involving 3GPP Release 16 sidelink mode 2 (autonomous UE) will be described.

When traffic arrives at a transmitting UE, it should autonomously select resources for the PSCCH and the PSSCH. Resource selection procedure is composed of two phases.

The first phase comprises resource sensing. The device senses the medium for a certain time duration before selecting transmission resources in order to estimate when the channel can be used for transmission. The transmitting UE measures the Reference Signals Received Power (RSRP) of all subchannels under consideration. To find out which resources are not occupied by other sidelink transmitters or which have an acceptable RSRP level, the Sidelink Control Information (SCI) of other sidelink transmitters must be decoded.

The second phase comprises the resource selection. This comprises, in some embodiments, a random selection of resources from a resource pool by eliminating some resources based on the above sensing procedure. Resources are scheduled via semi-persistent scheduling (SPS). The transmitting UE keeps performing sensing until it transmits. If another sidelink transmission with higher priority is detected then resource re-selection is triggered.

Wrong resource selection/allocations can lead to a number of subsequent collisions. This effect is most severe under heavy user traffic and dense network connectivity.

In 3GPP Rel-16, time granularity is given by the sub-frame (1 msec comprising of 14 OFDM symbols) and in the frequency domain the minimum allocation unit is the subchannel (12 subcarriers of 15 kHz each, i.e. 180 kHz). Each combination of time and frequency resource may be denoted as “resource unit”. The UE expects to use a same numerology in the SL BWP and in an active UL BWP in a same carrier of a same cell [3GPP TS 38.213].

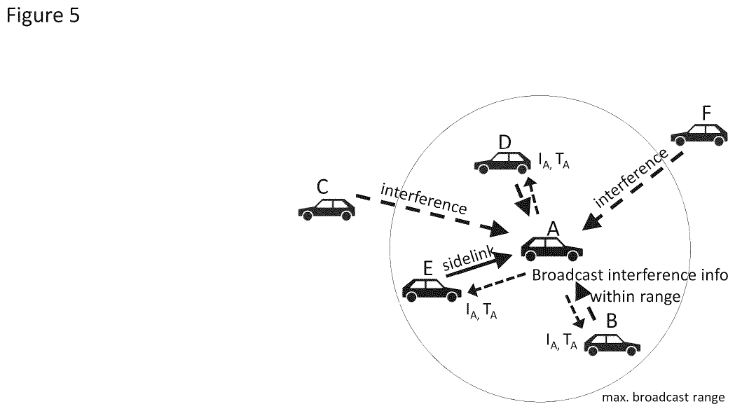

This approach is shown in FIG. 5. Asynchronous broadcasting via 2nd stage SCI is always sent in advance to a data block. 3GPP NR employs a two-stage SCI approach. The first stage SCI is transmitted via PSCCH. The second stage SCI is transmitted via the PSSCH resources.

The first stage SCI broadcasts fundamental information that can be decoded by all UEs in the surrounding. Among others, it may contain information about the time-frequency resources (e.g., sub-channels), MCS and priority of the associated PSSCH. The main purpose of first stage SCI is for resource sensing.

The second stage SCI carries remaining control information necessary for target receiving UEs to be able to decode the PSSCH transmissions.

In some embodiments, using the second stage SCI to broadcast the cooperation mode indicator and cooperation information due to flexibility in its size may be preferred. Particularly, the following two field extension is proposed for some embodiments:
X bits: Cooperation mode indicator
Y bits: Cooperation information (based on the indicator)
   Field 1: interference information (described previously)
   Field 2: transmit resource information (descried previously)
The cooperation mode indicator and cooperation information can be linked via a table as follows:

| Cooperation mode | |
|---|---|
| indicator (e.g., 2 bits) | Cooperation Information (Y bits) |
| 01 (corresponds to | Field 1: SINR |
| Cooperation Mode | Field 2: data rate demand/priority |
| A, e.g. load | Note: depending on the chosen Cooperation |
| balancing) | Strategy, a single field will suffice |
| 10 (corresponds to | Field 1: interference info |
| Cooperation Mode | Field 2: f(data rate demand, tx power) |
| B, e.g. power | Note: depending on the chosen Cooperation |
| minimization) | Strategy, a single field will suffice |

The Cooperation Modes will, in some embodiments, have to be defined by the respective standard. It is predefined among all UEs joining a coalition. In our proposal we only give a few examples as technical embodiments.

Moreover, using other mechanisms for broadcasting cooperation information is also conceivable. For example, sharing cooperation information via SS/PSBCH (SSB) block would be technically feasible as well. However, the original purpose of SSB broadcast is for synchronization information, using this fundamental mechanism for the present disclosure would be less likely to be adopted by the current 3GPP standardization, considering the status of Rel-16.

In the following, further details on the interference measurement are provided. The measurement of total interference I can be done in the following ways.

In one embodiment, measurement can be performed in the absence of a wanted signal (i.e., absence of PSSCH/PSCCH, e.g. in blank frames).

In a further embodiment, the measurement may be based on RSSI. The following example calculation proves plausibility of this approach.

$$Interference measurement to be standardized for \underline{sidelink} , \\ or can be derived from PSSCH - RSRP and SL RSSI$$

$$SINR = {p}_{n} / i interference i includes noise and is normalized with path loss g \text{?}$$

$${p}_{n} g \text{?} = ρ 12 NPRB RSRP load factor ρ , full load means ρ = 1$$

$$I = ( RSSI / g \text{?} ) - {p}_{n} RSSI = total power$$

$$\text{?} = pn ( \frac{RSSI}{ρ 12 NPRB RSRF} - 1 ) \text{?}$$

$$\text{?} \text{indicates text missing or illegible when filed}$$

The above approach may require knowledge of pₙ, which can be transmitted via the dedicated link.

In a further approach, the transmitting UEs can use multi-antenna techniques for transmission, known as beamforming, in order to realize directed antenna gains. This can be considered as part of the propagation channel.

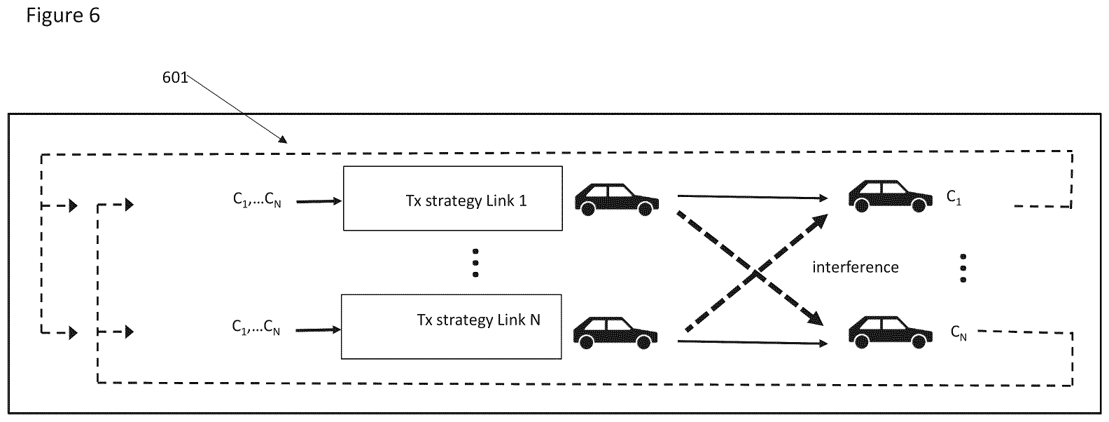

The following provides a description of how the cooperation information (interference and Tx resource information) are being processed at a UE in line with FIG. 6.

The processing may happen in an asynchronous manner where no synchronization between UEs is necessary.

The following description is based on the availability of Tx resources and interference information from all UEs in the vicinity. As mentioned elsewhere, the algorithm presented herein is able to tolerate missing information. There is no sudden breakdown but rather a “graceful degradation” of performance.

Broadcasted cooperation information from UE n may be denoted as Cₙ. This includes interference, tx resource information and cooperation mode indicator.

Based on the broadcasted information, joint optimization of power p, load ρ and rate d may be performed. For e.g., rates under given resource constraints, or usage of resources under given rate or QoS constraints may be optimized.

The optimization may be updated when new cooperation information from other UEs is available.

The FIG. 6 illustrates the broadcast and utilization of Cₙ.

In a first example, a max-min rate under load and power constraints may be performed. This encompasses broadcasting cooperation information and cooperation mode indicator to all UE within reach in step 601.

As part of this approach, p and d are updated jointly every time cooperation information Cₙ from a link n is available at a UE. Compared with the prior art according to [2], a single iteration step is performed after receiving new cooperation information via broadcast, and the Tx parameters are updated as follows:

$$[ \begin{matrix}{p}^{( s + 1 )} \\ {d}^{( s + 1 )}\end{matrix} ] = \frac{{P}_{max}}{‖ P ( {p}^{( s )} , {d}^{( s )} ) ‖} [ \begin{matrix}P ( {p}^{( s )} , {d}^{( s )} ) \\ {d}^{( s )}\end{matrix} ]$$

where ∥°∥ is a monotone norm, e.g. maximum, and P=[P₁ . . . P_{N}]^{T}. Examples of Pₙ, for given load ρ=[ρ₁ . . . ρ_{N}] are

$${P}_{n} ( {p}^{( s )} , {d}^{( s )} ) = ( {2}^{\frac{{d}_{n}}{{ρ}_{n} K B}} - 1 ) {I}_{n} ( ρ , p )$$

The initialization P(p⁽⁰⁾, d⁽⁰⁾) is arbitrary positive while Pₘₐₓ is the maximum allowed power per resource unit

In a further embodiment, power control may be performed as will be explained in the following.

Power control does not involve updating the load variable. For a given load,

$${P}_{PSSCH , SL \_ C} ( n ) ( p , {d}^{( s )} ) = ( {2}^{\frac{{d}_{n}}{{ρ}_{n} K B}} - 1 ) {I}_{n} ( ρ , p )$$

may be updated where the initialization P(p⁽⁰⁾, d⁽⁰⁾) is arbitrary positive.

The standard TS 38.213 defines open-loop power control according to

$${P}_{P S S C H} ( i ) = min ( {P}_{CMAX} , {P}_{MAX , CRB} , min ( {P}_{P S S C H , D} ( i ) , {P}_{P S SCH , SL} ( i ) ) ) [ dBm ]$$

Embodiments of the present disclosure may be implemented in this approach via

$${P}_{PSSCH} ( i ) = \{ \begin{matrix}\begin{matrix}min ( {P}_{CMAX} , {P}_{MAX , CBR} , \\ min ( {P}_{PSSCH , D} ( i ) , {P}_{PSSCH , SL} ( i ) ) )\end{matrix} & ; If cooperation mode indicator = 0 \\ \begin{matrix}min ( {P}_{CMAX} , min ( {P}_{PSSCH , D} ( i ) , \\ {P}_{PSSCH , SL \_ C} ( i ) ) )\end{matrix} & ; If cooperation mode indicator \neq 0\end{matrix}$$

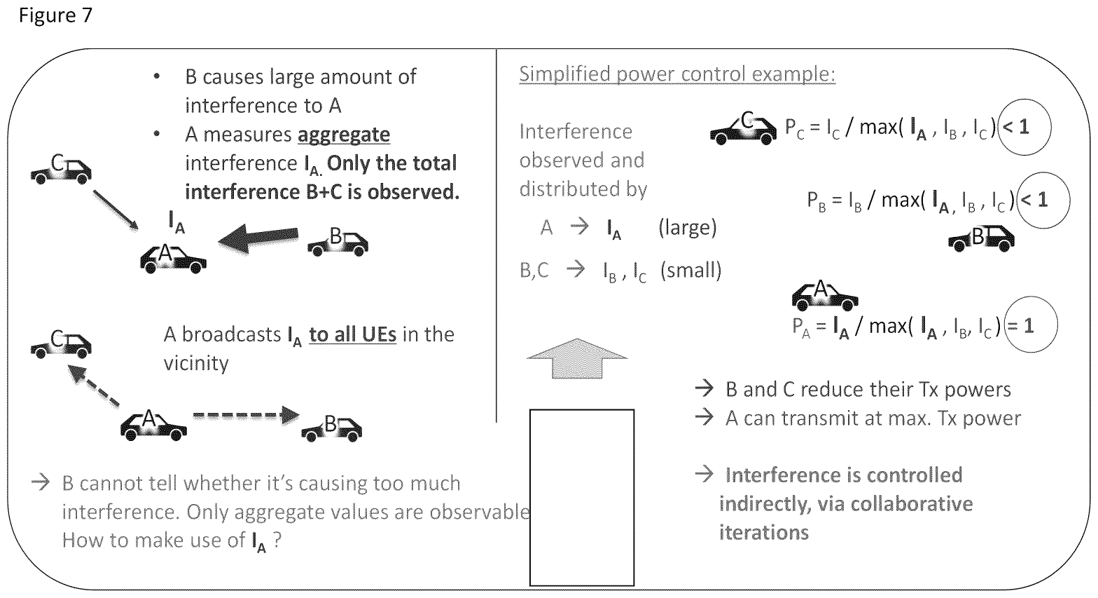

FIG. 7 illustrates some schematic explanations regarding embodiments of the present disclosure.

A second scenario of implementing the present disclosure may rely on the standard IEEE 802.11A. The present disclosure can enable Decentralized Congestion Control (DCC) in existing IEEE 802.11p networks.

IEEE Task Group 802.11bd (TGbd) defines the latest RAT evolution of IEEE 802.11p, which is backward compatible with 802.11p to support vehicular communications.

The MAC layer of IEEE 802.11p is based on carrier sensing multiple access with collision avoidance (CSMA/CA). Before every message transmission, the wireless medium is sensed for a certain pre-determined amount of time in order to estimate when the channel is idle or busy. Upon sensing an idle medium, message transmission occurs.

If the wireless medium is sensed busy at a transmitter, the transmitter defers its transmissions for a certain randomized time duration until the wireless medium is sensed idle for transmission.

Under high channel load conditions, the likelihood of simultaneous transmissions increases and the system is known to suffer from congestion

Congestion can lead to frame collisions, packet losses, increasing channel access delay, and a reduction of the effective transmission range.

Some further background information on DCC is provided below. The goal of DCC is to minimize packet collisions and provide similar channel access opportunities to all UEs under the same channel load conditions.

Commonly used metric for congestion control in IEEE 802.11p based networks is also CBR, which is a measure of the channel load.

CBR is defined as the ratio of the time the channel is perceived as busy and the overall observation time.

The previously discussed limitations of CBR (answer to question 3) also apply to IEEE 802.11p based networks.

Below; some further aspects on asynchronous broadcasting are discussed. There are two kinds of messages that can be periodically transmitted over the control channel (CCH) in IEEE 802.11p networks.

The first one is known as Beacons, which are short vehicular status messages on the MAC layer to support cooperative applications and neighborhood discovery. Typical beacon periodicity is in the range 100-200 ms, which is suitable for our proposal.

The second one is known as WSA (WAVE Service Advertisement, IEEE 1609.3) and contain management information about the announcement and availability of services.

Both beacons and WSAs are transmitted as one-hop broadcasts from a transmitting node.

Embodiments of the present disclosure allow for using WSAs and/or beacons to broadcast the cooperation mode indicator and cooperation information.

The vehicles may additionally be pre-configured with the cooperation mode indicator and cooperation information table as described above.

Below, some further information on interference measurements is provided. The total interference I can be measured at a UE in a similar way as in the above embodiments. In particular, there are two fundamental options.

One option is to measure I in the absence of the wanted signal, e.g. in the blank time slots. Alternatively, one embodiment may encompass exploiting knowledge of the transmitted link power and SINR, by using the following:
IEEE 802.11 received signal strength indicator (RSSI): it is or may comprise or be at least indicative of an indication of the amount of radio energy in the channel being received by the receiving radio after the antenna and possible cable loss.
IEEE 802.11 received channel power indicator (RCPI): it is a measure or indicative of such measure of the received radio frequency power in a selected channel over the preamble and the entire received frame, and has defined absolute levels of accuracy and resolution.

Below, a third scenario in the context of UE-UE CLI mitigation will be described.

The coexistence of different link directions over same frequency resources in adjacent cells can result in potential cross link interference (CLI). In particular, this embodiment focuses on the case of user-to-user (UE-UE) CLI mitigation, as shown in FIG. 8.

The here described embodiment pertaining to 3GPP Rel-16 extends NR with new features for CLI mitigation to allow more flexible and adaptable resource sharing in unpaired spectrum, with variable transmission time interval (TTI) duration and flexible switching points that may be slot-dependent instead of being frame-based, e.g., with time granularity in the order of milliseconds.

The embodiments described may be beneficial for this scenario since they allow to mitigate the CLI between UEs in adjacent cells by means of adapting the transmit resources (i.e. rate demands, power, load), as described in the main part.

The following aspects are particular for the implementation of the UE-UE CLI mitigation embodiment.

The total interference may be measured, averaged over a certain time window, with a duration that is flexibly configurable depending on the needs (e.g. adaptation to channel fluctuations, etc).

The measurement may be based on RSSI. 3GPP defines CLI measurement [TS 38.215, “NR: Physical layer measurements”] It defines CLI-RSSI (CLI Received signal strength indicator). CLI-RSSI is the linear average of the total received power (in [W]) observed only in the configured OFDM symbols of the configured measurement time resource(s), in the configured measurement bandwidth from all sources, including co-channel serving and non-serving cells, adjacent channel interference, thermal noise etc.

Measurement may be performed in the absence of a wanted signal, e.g. in blank frames or slots.

Interference measurements may be wideband or subband or both. The measurement bandwidth can be configured by PHY (Layer) signaling.

Also, the measurements may include short-term measurements and long-term measurements or at least one of these two.

In the prior art, also interference measurements of dominant CLI sources from individual UEs have been proposed, e.g., based on RSRP measurement of the Sounding Reference Signal. However, as discussed already, such previous approaches are more complex and introduces more signaling overhead than embodiments of the present disclosure, which is based on measuring the total interference (only).

Mechanisms for the exchange of Cooperation Information between UEs belonging to different cells that cause CLI due to geographical proximity to each other (Inter-Cell Coordination Scheme) may be provided according to one of several options.

A first option uses existing network coordination mechanisms, for in-coverage UEs. For the CLI embodiment, in-coverage can be assumed.
UE1-gNB_1: e.g., via Uplink Control Information (UCI). To this end, the UE establishes Radio Resource Control (RRC) connection with the gNB. Note: 3GPP defines “CLI measurement object”.
gNB_1-gNB_2: Cooperation Information is then exchanged between the RAN nodes via one or more interfaces, Xₙ interfaces, which provide backhaul communication and coordination between gNBs.
gNB-UE2: Then, the information is forwarded to the other UE via Downlink Control Information (DCI).
The DCI is the equivalent of the SCI in the downlink. The same combination of indicator field, transmit resources, and total interference measurement is proposed.
Or, any other means of BS-BS information exchange provided by the network node apparatus. The second option uses a sidelink mechanism (possible for both out-of-coverage and in-coverage): Using NR sidelink broadcast signaling as in our main Embodiment 1, based on the 2-stage SCI defined for sidelink connectivity
A UE going into cooperation mode decides to periodically broadcast cooperation information to all UEs in the surrounding. This decision can be taken by the UE itself (e.g. in autonomous mode, out-of-coverage) or can be decided by the network, e.g. configured via RRC (in-coverage).
In order to enable broadcast signaling, the UE is transmitting synchronization signals on a regular basis (e.g. Sidelink Synchronization Signal SLSS).
Also, the UE is searching for other UEs providing synchronization reference. For this search it uses the SLSS ID, which is selected from an SLSS ID set. The SLSS ID is in the range from 0 to 335.

Case 1: arbitrary SLSS ID: A receiving UE has no way to know the SLSS ID and thus should search all SLSS IDs

Case 2: pre-configured SLSS ID for CLI mitigation assigned to UEs near the cell edge.
Synchronization procedure: a UE receives a SL Synchronization Signal (S-SS)/PSBCH block used to broadcast system information over the entire sidelink coverage area. The S-SS/PSBCH block is typically transmitted periodically every 160 ms, but the periodicity can be configured.
PSCCH instances carry a stage-1 SCI message, which contains information used by the receiving UEs to decode the associated PSSCH sequence.

Embodiments of the present disclosure also allow for forming coalitions across cell borders. For such cases, generally, the same principles discussed above also apply to the UE-UE CLI avoidance. That is, any UE can join or leave a coalition any time.

According to a predefined UL-DL configuration, the UE may be configured to perform CLI measurement or not. In particular, UEs at the cell border (which are more prone to UE-UE CLI), may be configured by the RLC to go into a certain cooperation mode and share Cooperation Information with UEs from neighboring cells.

The algorithm for distributing resource control may be the same as was already discussed above.

FIG. 9 shows a plurality of devices 901 to 904 that can participate in sidelink communication. The devices 901 to 904 may, for example, be realized or may encompass smartphones or laptops or tablets or may also encompass devices that can participate in sidelink communication and are provided as part of vehicles like, cars.

Each of the devices 901 to 904 can be realized in a different way so that, for example, the device 901 can be realized as a smartphone whereas the device 904 pertains to an entertainment system of a vehicle, like a car. The devices 902 and 903 could likewise be realized as smart phones or as vehicles or as other mobile devices like laptops or tablets.

Embodiments of the present disclosure may particularly pertain to devices (as will be described in further detail with respect to FIG. 12) that can participate in sidelink communication as is known, for example, from the standards IEEE 802.11p.

More in particular, two devices (for example the devices 901 and 902) that participate in sidelink communication with each other communicate with each other in a way that one of the devices is, at least for a specific time period, in transmission mode whereas the respective other device is in receiving mode. The devices can change between the transmission mode and the receiving mode depending on whether they are to send information to the other device (transmission mode) or whether they are to receive information (receiving mode). Depending on the characteristics of the devices, they can also be in transmission and receiving mode at the same time.

In any case, though the signals of the devices participating in the sidelink communication are usually broadcast so that there is an omnidirectional sending of signals by each device when in transmission mode, the communication is only established between a specific pair of devices while the other devices, though receiving the respective signals, are not able to understand these signals and may thus experience these signals as “noise” or interference, as was already explained above.

Specifically, in FIG. 9, the devices 901 and 904 may be considered participate in sidelink communication with each other as indicated by the arrows 914. Devices 902 and 903 also participate in sidelink communication with each other as indicated by the arrows 923 but do not participate in sidelink communication with the devices 901 and 904.

Due to the broadcasting of the signals pertaining to the sidelink communication, however, electromagnetic signals are transmitted by each of the devices 901 to 904 when in transmission mode are in principle also received at each of the other devices. As the respective signals are only intended for the respective device with which a particular device is in sidelink communication, the other devices do not further use and cannot use the respective signals but receive the electromagnetic energy as “noise”.

If the devices 901 to 904 make use of the same resource units (for example the same frequency bands), congestion may be caused because, in addition to the actual signal intended for a particular device that participates in sidelink communication, the device also receives “noise” from other sources which might deteriorate the signal quality as the signal strength compared to the surrounding noise level might be comparably small.

Thereby, the quality of the received signal and the quality of the sidelink communication may be significantly reduced.

On the other hand, as the sidelink communication takes place between two specific devices at any point in time, providing congestion control is particularly difficult.

However, as each of the devices 901 to 904 can change between a transmission mode in which it transmits electromagnetic signals with a given transmission power, for example, and a receiving mode where it acts as a receiver for electromagnetic signals, each device can obtain information on its own transmission power and/or electromagnetic interference (or noise) experienced when in receiving mode.

It is a finding of the present disclosure that particularly by using the own transmission power and information on measured interferences from other devices, it is possible to obtain congestion control in a way that does not depend on all devices in the surrounding actually participating in a congestion control approach and without the need of a centralized management, by allowing each of the devices 901 to 904 to adjust their own transmission parameters based on information received from the other devices and information obtained on their own.

This will be explained further with respect to the FIGS. 10 and 11 and was partially already described in relation to FIGS. 1 to 8 above. The explanations given with respect to FIGS. 1 to 8 above are considered applicable also for the embodiments that are described in the following.

FIG. 10 shows a method of initializing a cooperation or coalition between devices that can then allow for performing congestion control as will be described in the following in FIG. 11.

The method 1000 as depicted in a flowchart in FIG. 10 begins with a first step 1001 in which a total interference in at least one frequency band is measured by a device (for example any of the devices 901 to 904) that participates in sidelink communication. This measuring of the total interference may be performed by the device while it is in receiving mode. In receiving mode, the respective device receives electromagnetic signals where a particular signal is targeted for this device because it originates from the device that participates in sidelink communication with the respective device that is in receiving mode when performing the step 1001. For example, assume that the device 904 is in receiving mode. In that case, the device 901 may be in transmission mode and provides electromagnetic signals to the device 904 as part of the sidelink communication. The other devices 902 and 903 may, at the same time, be both in transmission mode or at least one of them may be in transmission mode.

This will result in the device 904 not only receiving a signal from the device 901 which is actually intended for the device 904 but further receiving an interference signal originating from one of the devices 902 or 903. This interference corresponds to an electromagnetic energy that can be measured by the device 904 when in receiving mode.

After having performed the respective measurement or before having performed the respective measurement in step 1001, the particular device may be caused to enter a cooperation mode for a sidelink communication channel so as to participate in a coalition or cooperation to perform joint sidelink communication congestion control.

In step 1002, the device (like the device 904) may evaluate whether conditions for participating in such a cooperation or for causing a cooperation mode are actually met and, if so, causing a cooperation mode. One of those conditions may for example be that the measured total interference of step 1001 exceeds a particular threshold (measured for example in dB). If the measured interference is below this threshold, the device can conclude that the interference in the surrounding which may or may not be caused by other devices that participate in sidelink communication is negligible and does not significantly impact the sidelink communication in which the device participates.

In such a case, it can be more efficient with respect to the energy consumption of the respective device to not participate in a coalition or to not initiate such a coalition as the resources (specifically the required energy) for performing congestion control may be comparably large and may even be larger than other means that can be used for dealing with the interference received (including for example a slight increase in the transmission power).

Another condition may for example encompass that the particular device receives a coordination request from another device, like the device 902 or the device 903. Also the device 901 with which the device 904 which is considered as carrying out the method according to FIG. 10 for explanatory purposes is already in sidelink communication may issue such a cooperation request. The cooperation request may be a cooperation message as will be explained below with respect to step 1003.

If such a request is received at the particular device, the device may “decide” whether or not it is to join in a cooperation or coalition to perform congestion control. This may depend, for example, on predefined user settings where the user might have indicated that they do not wish to participate in congestion control. Furthermore, this decision may be made depending on for example quality of service (QOS) requirements.

If, for example, a contract of the user indicates that the user will always participate in sidelink communication with a particular transmission power, or their communication will be treated with a particular priority over any other communications, the device may decide, even when receiving a cooperation request, to not join the respective coalition. In such a case, the device can further be adapted to ignore further cooperation requests even if they are received on a periodic basis.

Another condition that may be checked may be whether the device is actually set to periodically send cooperation messages in order to request other devices to join the coalition on a voluntary basis as described above with respect to the receiving of a cooperation request.

The periodic sending may take place every second or every ten seconds or every minute or at any other periodic timeframe. This may depend on for example how volatile changes in the measured interference actually are. If the interference, for example, takes a specific value and only slightly fluctuates around this value for a comparably long period of time (several seconds, for example), it may be more appropriate to send cooperation messages less often whereas, if there is high fluctuation in the measured total interference, the device may send the cooperation mode messages more often.

Depending on which of the above conditions is actually met or whether other conditions are met that indicate that the cooperation mode is to be caused by the first device, the first device (like the device 904) sends, in step 1003, a cooperation message. This cooperation message will contain the measured total interference received at the particular device and will additionally comprise a cooperation mode indicator.

The cooperation mode indicator will provide information on a strategy of how the congestion control is to be performed. Particularly, the cooperation mode indicator may take one of several available values that each indicate a possible mode of performing congestion control and are predefined. In preferred embodiments, these possible modes are known to all devices that could potentially participate in congestion control according to embodiments of the present disclosure. For example, the respective modes may be provided on each of the devices in a lookup table and the cooperation mode indicator may take the form of a pointer to a specific entry in the lookup table.

Each of these modes can preferably define at least one optimization goal and processing strategies for cooperative radio resource management. Devices that agree to join a coalition upon receiving a cooperation message from a particular device that includes a specific cooperation mode indicator will, according to embodiments of the present disclosure, also agree to optimize their performance in line with the particular cooperation mode that was indicated by the cooperation mode indicator.

In some embodiments, the cooperation mode indicator may have a size of one bit (indicating either that cooperation is intended (when taking the value 1, for example) and indicating that cooperation is not intended when taking another value (taking the value 0), for example).

In other cases, the cooperation mode may have a length of two bits to indicate four different modes of cooperation. A first mode may, for example, encompass that load balancing is to be performed among the devices participating in the coalition. A second mode may for example indicate that the transmission power is to be minimized so as to minimize the interference caused by the devices.

Additionally, the cooperation message may (but does not need to) include cooperation information which may encompass for example a value indicating a signal to interference plus noise ratio (SINR) or a data rate demand of the particular device that sends the cooperation message or a priority of the data transmission of the particular device. Other information may for example relate to the transmission power of the particular device when it is in transmission mode or a sidelink ID indicating an identification of the sidelink communication the particular device participates in. Also a sidelink direction or a device ID may be provided. Likewise, a power demand or a periodicity of sending the cooperation message may be included as information in the cooperation message.

However, according to embodiments of the present disclosure, this additional information is not mandatory. For achieving congestion control, it is sufficient in at least some embodiments to provide a cooperation message that indicates the cooperation mode via the cooperation mode indicator and provides interference information indicative of a measured total interference power received at the particular device.

When receiving such a cooperation message at another device (for example the device 902), the cooperation message may act as an invitation for this particular device to start performing congestion control by joining the coalition and performing for example transmission power control based on the interference information and/or based on additional information so as to achieve the optimization goal that is indicated by the cooperation mode indicator.

As indicated by the arrow 1004, the method may be repeatedly performed so as to realize a method for congestion control.

This is further described in relation to the flowchart pertaining to a method for performing congestion control in line with FIG. 11.

The method 1100 described in FIG. 11 starts with a first step 1101 at which a particular device (for example the device 902), upon receiving a cooperation message from another device (like the device 904) or upon determining in step 1002 that a particular condition is met as explained above, decides to participate in a coalition with other devices in order to perform congestion control.

Once the device has decided to join this coalition, it will process cooperation messages the device receives as is exemplarily indicated in step 1102. This may encompass processing the cooperation message upon which the device has decided to join the coalition in step 1101 or only processing, from that message on, all subsequent messages but not that particular message received in step 1101.

The processing of the cooperation messages may comprise, for example, extracting, from the cooperation messages received, the cooperation mode indicator to determine whether a particular cooperation message actually refers to the particular coalition to which the device decided to join and/or to determine the strategy to be applied for optimizing transmission parameters. This determination can be based for example on the cooperation mode indicator indicating a particular mode of cooperation. If this mode is not in line with the mode of performing congestion control for the coalition to which device joined, the device may disregard the respective cooperation message.

Furthermore, processing of cooperation messages may involve processing the interference information included in the cooperation message. This may encompass obtaining the total interference power measured by the other devices that sent the cooperation messages received in step 1102. Upon that or before that or at the same time, the device may measure the total interference in at least one frequency band that the device experiences when being in receiving mode in step 1103.

With this information, the device may then adjust, in step 1104, at least one transmission parameter based on the information obtained from the cooperation messages and/or the total interference measured when being in receiving mode in step 1103. This may encompass, for example, calculating a transmission power for the particular device by obtaining a power factor by dividing the total interference power measured by the particular device by the maximum value of all measured interference powers, including the interference power measured by the device itself and all measured interference powers that were included in the cooperation messages received in step 1103.

By multiplying the initial transmission power with this power factor which will either be equal to 1 or smaller than 1, the transmission power as one transmission parameter is either maintained or reduced depending on whether the device itself experiences high interference from surrounding sources or whether it receives comparably small interference from neighbouring sources.

This approach is performed by each of the devices in isolation preferably only by using information contained in the cooperation messages and their own measured total interference.

Thereby, and because the totally measured interference also takes into account signals sent by devices that do not participate in the respective coalition, a reliable control of the transmission parameters of each of the devices participating in the coalition can be ensured, thereby improving the quality of the sidelink communication.

Having adjusted the transmission parameter in step 1104, a subsequent step 1105 can be performed at which the device once again measures the total interference received in at least one frequency band or all available frequency bands. After that, at least the total interference measured in step 1105 can be included in a cooperation message, which is then sent in step 1106 by broadcasting it so that other devices can receive it and the process starts again in step 1102.

By repeating this process for example several times per second, an iterative adjustment of the transmission parameters (for example the transmission power as exemplified above) is performed, thereby resulting in the transmission parameters of all devices being optimized towards a particular goal. The example mentioned above and making use of the total measured interference and the transmission power of the particular device is not to be understood as limiting the present disclosure to a particular implementation of congestion control. Rather, also other transmission parameters may be optimized and these transmission parameters may be optimized also in a different way compared to what was described so far.

Other approaches and particularly other goals as well as mathematical methods for optimizing particular transmission parameters have already been described above and will not be repeated here but are considered to be encompassed by this embodiment as well.

It is noted that at any given point in time, a particular device can decide to no longer participate in the coalition and, from that time on, stop sending cooperation messages. Nevertheless, the device may still participate in sidelink communication or other wireless communication means, thereby causing at least some portion of the total interference measured by other devices. Irrespective of whether or not a particular device thus participates in the respective coalition, its contribution to the totally measured interference is recognized by the other devices when measuring the total interference, thereby resulting in, even though the particular device is not participating in sidelink communication or in congestion control as the other devices, the interference caused by this device being taken into account and resulting in a corresponding optimization of the transmission parameters of the devices that still participate in the congestion control.

It can also be provided that one or more devices that originally joined a particular coalition decide to take a different approach of performing congestion control and to therefore leave the respective coalition. They may then use another mode of how to adjust the transmission parameters. In that case, even though these devices do no longer participate in the respective coalition, their contribution to the total interference is taken into account as the other devices measure the signals sent by the devices that left the coalition.

In some embodiments, it can also be provided that cooperation messages that indicate a different cooperation mode indicator than the cooperation mode in which a particular device actually participates are taken into account in so far as they include information on total interference measured by the devices that joined, for example, a different coalition. This can be advantageous in order to adjust the transmission parameters as, even though the particular devices did not join the same coalition, adjustment of the transmission parameters by taking into account the interference measured by these devices may, overall, result in improved congestion control. This is, however, only optional and not mandatory.

In any case, the adjusting of a transmission parameter may comprise adjusting at least one of the transmission power (as explained above already with respect to FIG. 11), adjusting a transmission load or a data rate or a position of used resources or a number of used resource units like for example adjusting the number of frequency bands over which a particular device transmits signals involved in the sidelink communication.

Particularly, it can be provided that, depending on the information received as part of one or more cooperation messages, the device stops sending information pertaining to the sidelink communication in a first frequency band but continues sending sidelink communication (for example with increased transmission power) in a second frequency band associated with the sidelink communication.

FIG. 12 depicts a device 1200 that may participate in sidelink communication and may also participate in a coalition for performing congestion control as was explained above with respect to FIGS. 1 to 11. The device may be realized as a smartphone, laptop, tablet or any other device and may, for example, also form part of a vehicle.

The device 1200 may comprise a processor 1201 that can be realized for example as a general purpose CPU and may additionally or alternatively comprise a graphics processing unit (GPU) to perform specifically dedicated tasks. Additionally, the device 1200 may comprise a receiver 1202 and a transmitter 1203. The receiver and/or the transmitter may be connected with the processor by means of data and/or energy transfer that allow the processor to control the receiver and/or the transmitter.

Particularly, these means can comprise data connections like cables with which electromagnetic signals or electric signals can be sent from the processor to the receiver and/or the transmitter or vice versa. Particularly, the processor may be configured and adapted to control the transmitter to transmit signals as part of a sidelink communication in line with an adjustment of transmission parameters as performed for example in accordance with FIG. 11. The processor may further be adapted to control the receiver to measure the interference received at the device 1200 in addition to a signal pertaining to the particular sidelink communication in which the device participates in.

Moreover, the device 1200 may comprise a memory 1204 (like a solid-state memory) on which, for example, information encoding cooperation modes may be stored or any other information may be made available to the processor of the device 1200.

Generally, the device 1200 comprising a receiver 1202, a transmitter 1203 and a processor 1201 may be realized so that the processor is suitable for causing a cooperation mode over a sidelink communication channel, wherein the cooperation mode is indicative of performing joint sidelink communication congestion control. Furthermore, the transmitter 1203 may be suitable for broadcasting a first cooperation message, wherein the first cooperation message comprises a cooperation mode indicator and interference information indicative of a measured total interference power received via the receiver 1202, wherein the cooperation mode indicator is indicative of the cooperation mode.

The device described in relation to FIG. 12 may be particularly suitable for and adapted to perform any of the methods of congestion control as described above or arbitrary combinations thereof.

What is claimed is:

1. A method for sidelink communication congestion control, the method comprising:
enabling, by a first device, a cooperation mode over a sidelink communication channel,
wherein the cooperation mode is used to perform joined sidelink communication congestion control; and
broadcasting, by the first device, a first cooperation message,
wherein the first cooperation message comprises a cooperation mode indicator and interference information indicative of a measured total interference power received at the first device,
wherein the cooperation mode indicator is indicative of the cooperation mode, and
wherein one or more second devices are invited to join the coalition based on the first cooperation message.

2. The method according to claim 1, wherein enabling the cooperation mode is performed based on at least one of:
the first device detecting at least one of an interference power exceeding a threshold,
receiving a coordination request from at least one second device; and
periodically sending of cooperation message by configuration.

3. The method according to claim 1, wherein the first cooperation message further comprises at least one of: a transmission power of the first device, a sidelink ID, a sidelink direction, a device ID, a load, a priority, a rate demand, a power demand, and a periodicity of sending the first cooperation message.

4. The method according to claim 1, further comprising:
receiving a second cooperation message from a second device, and/or
participating in a coalition based on the second cooperation message or ignoring the second cooperation message.

5. The method according to claim 1, further comprising adjusting at least one transmission parameter associated with the sidelink communication at the first device.

6. The method according to claim 5, wherein the transmission parameter comprises at least one of a transmission power, a transmission load, a data rate, a position of used resources, a number of used resource units.

7. The method according to claim 1, wherein the cooperation mode comprises an optimization of one transmission parameter or the joint optimization of at least two transmission parameters,
wherein the cooperation mode optionally comprises an optimal operating point of the plurality of participating devices regarding at least one jointly available resource.

8. The method according to claim 7, wherein the jointly available resource comprises an available link rate.

9. The method according to claim 1, wherein the interference information indicative of a measured total interference power comprises information on measured interference in at least two distinct frequency bands.

10. A device comprising a receiver, a transmitter and a processor,
wherein the processor is configured to enable a cooperation mode over a sidelink communication channel, wherein the cooperation mode is indicative of performing joined sidelink communication congestion control;
wherein the transmitter is configured to cooperate with the processor to broadcast a first cooperation message that comprises a cooperation mode indicator indicative of the cooperation mode and interference information indicative of a measured total interference power received via the receiver.

11. The device according to claim 10, wherein the processor is configured to enable the cooperation mode over the sidelink communication channel based on at least one of:
detecting at least one of an interference power exceeding a threshold;
upon receiving a coordination request from at least one second device; and
periodically sending of cooperation message by configuration.

12. The device according to claim 10, wherein the first cooperation message further comprises at least one of a transmission power of the first device, a sidelink ID, a sidelink direction, a device ID, a load, a priority, a rate demand, a power demand and a periodicity of sending the first cooperation message.

13. The device according to claim 10, wherein:
the receiver is configured to cooperate with the processor to receive a second cooperation message from a second device, and/or
the processor is configured to enable the device to participate in a coalition based on the second cooperation message or ignore the second cooperation message.

14. The device according to claim 10, wherein the processor is configured to adjust at least one transmission parameter associated with the sidelink communication at the device.

15. The device according to claim 14, wherein the transmission parameter comprises at least one of a transmission power, a transmission load, a data rate, a position of used resources, a number of used resource units.

16. The device according to claim 10, wherein the cooperation mode comprises an optimization of one transmission parameter or the joint optimization of at least two transmission parameters, wherein the cooperation mode comprises an optimal operating point of the plurality of participating devices regarding at least one jointly available resource.

17. The device according to claim 16, wherein the jointly available resource comprises an available link rate.

18. The device according to claim 10, wherein the interference information indicative of a measured total interference power comprises information on measured interference in at least two distinct frequency bands.

19. A non-transitory computer-readable storage medium comprising computer-executable instructions that, upon being executed by a computing device as a first device, cause the computing device to perform a method including:
enabling, a cooperation mode over a sidelink communication channel, wherein the cooperation mode is used to perform joined sidelink communication congestion control; and
broadcasting, a first cooperation message that comprises a cooperation mode indicator indicative of the cooperation mode and interference information indicative of a measured total interference power received at the first device,
wherein one or more second devices are invited to join a coalition based on the first cooperation message.

20. The non-transitory computer-readable storage medium according to claim 19, wherein enabling the cooperation mode is performed based on at least one of:
the first device detecting at least one of an interference power exceeding a threshold,
receiving a coordination request from at least one second device; and
periodically sending of cooperation message by configuration.
